(19) United States
(12) Patent Application Publication
(10) Pub. No.: US 2010/0006281 A1
(43) Pub. Date: Jan. 14, 2010

(54) Harvesting hydrocarbons and water from methane hydrate deposits and shale seams

(75) Inventor: Denyse Claire DuBrucq, Cedarville, OH (US)

Correspondence Address: Denyse DuBrucq, 100 W. Elm St., Cedarville, OH, 45314-8575, US

(73) Assignee: Air Wars Defense lp, Cedarville, OH (US)

(21) Appl. No.: 12/217,915

(22) Filed: Jul. 9, 2008

(51) Int. Cl. E21B 43/285; B01D 5/00

(52) U.S. Cl. 166/249; 203/87; 166/371

(57) ABSTRACT

A method of extraction of fuels, organic pollutants, and elements from Methane hydrate deposits, shale seams and the soil is described which freezes the zone and heats the center carrying the fuel, chemicals and water in these deposits and seams from where they are found, be it deep in the sea or on land, and carries them into the condensing unit in inert Nitrogen gas. Required drilling on the surface or sea bottom includes a main shaft and with auxiliary narrow drillings widely spaced from the shaft. The extraction zone, which is first cooled to brittle cold using the evaporation of Liquid Nitrogen and fractured with vibrations, is heated to the highest temperature of the hydrocarbon fraction desired to be extracted. The evaporating hydrocarbons are extracted in a Nitrogen gas carrier, a recognized fire suppressant (NFPA Code 2000). To speed the extraction rate, tonal input from two or more sounding units vibrates the seam structure freeing the evaporated hydrocarbons allowing more rapid escape into the shaft. To prevent air loss in aquifers, ice barriers seal the zone periphery. These hydrocarbons are separated into the hydrocarbons fractions, into fuel fractions as heating oil, kerosene, gasoline, ethers, and fuel gas including methane, Argon/Oxygen and rare gas segments, or, if pollutants, into the separate chemicals by boiling point. The thermal gradient of the extraction pipe is implemented by sourcing the Nitrogen from Liquid Nitrogen and bundling those pipes with the extraction pipe condensing its contents by hydrocarbon fractions into vessels and gas drums depending on boiling points of fractions. Water is separated from the gasoline segment and purified first by separation and then by freezing. The extraction of deep deposits layer the extraction zones as well as work neighboring extraction zones covering many acres. Fuel gases can be liquefied or burned in an on-site electric generating plant.

### BACKGROUND OF THE INVENTION

1. Field of the Invention

Like the world's coal and shale. reserves which often pose difficulty in harvesting the fuel components, harvesting the light fuel gases and the fresh, distilled water from Methane Hydrate deposits needs a workable tool. Extraction using a modification of the equipment described in the U.S. patent application Ser. No. 11/903,346 can bring the fuels and water to locations where it will be useful. And, because fuel, Methane with minor amounts of Butane and Propane, could be used at the platform over the deep extraction process to produce electricity an electric power generating plant can be located at the extraction site. The electric power can be carried to land in a huge insulated cable(s) along side distilled water pipeline providing electricity and potable water to local populations. For concerns of Global Warming, the Carbon dioxide emission from burning the heating gases can be frozen as dry ice when in darkness and along with currently produced Carbon dioxide can be used to provide the carbon source for photosynthesis for kelp, plankton and other sea plants during daylight.

Thermally, Liquid Nitrogen is minus 195.8° C. Petroleum fractions in the Methane hydrate includes:

| | Melting Point | Boiling Point |
|---|---|---|
| Methane | −183° C. | −164° C. |
| Ethane | −183° C. | −89° C. |
| Propane | −190° C. | −42° C. |
| Butane | −138° C. | −0.5° C. |
| Water | 0° C. | 100° C. |

These heating gases can be stored as bottled gas or burned on the site to produce electricity. The distilled water can be sent by pipeline to local shore for consumption. To prevent heating gas flash in the extraction, pure Nitrogen gas is inserted in the extraction drilling and will be the carrier for the evaporated organics and water.

Economically, extraction is done with all personnel at ground level or on the platform over water, and the heat and tone causing the breakdown and evaporation of the light and medium weight organics. The method requires drilling, available Liquid Nitrogen to provide condensing and cooling, pure Nitrogen gas for extraction, and power for the heating element either electrically or by heating by fuel gas. Liquid Nitrogen can be generated on site from the exhaust pure Nitrogen gas from the condensing process.

Physiologically, the Methane hydrate deposit workers will have little exposure to the methane and water being extracted because of the closed system provided by the chemical processing of contained condensation separation. With the limited types of hydrocarbon, total heating gas extraction is expected. The heating gas can be bottled for shipment to use sites at the platform or site, or the heating gas can be burned to produce electricity which is cable-sent to the use sites in parallel with pipelines for fresh distilled water. The Carbon dioxide from the burn is contained and water from the burn either added to the fresh water pipeline load or released into the water. Carbon dioxide can be bubbled through kelp beds or plankton fields in the ocean waters during periods of sunlight and be stored as dry ice during periods of darkness to be released during light. The extraction teams will have fresh air. Fire safety is handled in the closed systems and with the fact that extraction is done in the fire suppressant Nitrogen gas. Liquid Nitrogen is available at all times to end any type of fire including electrical in the incidence that a fire of any kind breaks out. Exhaust Nitrogen can be fed into the compressor to drive the pneumatic hammer drill which provides the initial Nitrogen saturation in establishing or expanding the extraction zone.

Tonal vibrations may not be necessary in this Methane hydrate extraction since if the material is solid, the heat transfer to melt the material is consistent through the process of evaporating the substrate. Without fracturing the material, there is less chance of collapse of the material over the deposit into the space of the deposit. In contrast to coal, shale, peat and landfill materials, the Methane hydrate is entirely evaporated in the extraction process and all of that material is preserved and transferred to use sites. If the vibrational fracture of the material is helpful, the frequency is optimized that will cause the greatest fracture for the least generated sound for the Methane hydrate material.

Convection in the Methane hydrate deposits are maintained after the initial evaporation by both inserting narrow drillings in ring patterns around the extraction drilling using compressed Nitrogen gas coming from the condensation system in operating the pneumatic hammer drill where the outer ring uses the coal mine fire equipment to insert pure Nitrogen gas into the layers being extracted, and, to insure continuity of the passage of the evaporant from those regions by inserting ring strengthened expanding piping from the point of initial extraction to the extent of the planned evaporation of that section of the deposit. The first is done as described in the initial patent filing Ser. No. 11/903,346. The second is done after the space is created by evaporating the center of the Methane hydrate area of the deposit and then creating a double closed compartment entry to that space to transport eight sections of collapsed tubing that will extend to the far regions of the evaporation in this extraction location and a pair of robots that will assemble and extend the reach of the tubing as the evaporation process continues. This prevents early ending of the extraction process if the material over the deposit collapses. The tubing sections will survive enabling the evaporant from the later treated sections of the deposit extraction region to reach the center point for extraction. The limits of this region are expanded by drilling small diameter holes and applying a Liquid Nitrogen rain down the tubing adding Nitrogen carrier gas to move the evaporated Methane hydrocarbon material to the extraction site. Expanding further, these holes will be filled with heating units which evaporate the Methane hydrate in that area which will be carried to the center for extraction by the Nitrogen gas flowing from still further out holes where the Liquid Nitrogen enters. This expansion limits the melting on the outer perimeters of the extraction region and extends the zone heating the material so it evaporates and flows to the center. The robot expanded tubing will have segments going to each section of the deposit where the heating units are placed for the full extent of the region of deposit being extracted for that location. Inserting first ring when evaporation has reached the distance to that point in the matrix provides the external Nitrogen to push further evaporated Methane hydrate into the extraction drilling. To expand the range of the extraction, a second ring of narrow drillings is made and the pure Nitrogen is inserted there while the inner ring holes are refitted with heating units comprise of, for instance, tube boilers with heating units inside them. To concentrate the pure Nitrogen gas input, the water passage to the sea bottom can be through ribbed tubing, because it can contort with water convection differing at the various levels it passes through, or a heavy metal vessel to where the sieve unit is placed. This Nitrogen gas generation is concentrated in the area of the deposit by having vessel attach at or the pipe sealing the outside of the hole down to the layer of the Methane Hydrate deposit where it is released. To concentrate the heat in the inner narrow drillings, the narrow drilling is insulated to contain the heat emitted in the Methane hydrate deposit.

To continue the range of technology applications to drawing from the ground organic pollutants using this same method will clear the ground of organics and isolate, collect, and quantify the amount of the pollutants that is removed. This is expected to rid the soil of the targeted pollutants preventing further contamination of ground waters, the air, and eventually ending its affect of life in the region. Variance in the application is that these extractants are found at the surface of the ground requiring possible insulation of the ground during extraction and reduced costs of drilling to reach extraction zones.

When encountering underground water sources as aquifers and other porous rock, whether they are open caves or rock laden wet zones, there may be loss of extracted material, a slowing of output, because the Nitrogen and its contents of evaporated materials are escaping in an open area over the water level in the aquifer. To block this loss of output and to insure the extraction through this depth is similar to other layers, water can be drawn from areas not frozen and sprayed into the cryogenic cold areas such that the resulting ice forms a secure barrier underground preventing the loss of gases from above the water level in the aquifer or the open zones in the porous rock.

The present invention relates to cryo-technology providing pure Nitrogen gas cooling for the fracturing, if appropriate, of the Methane hydrate material when it is brittle with the cold temperature and then providing the wind power of the Nitrogen gas to activate the vibro-tonals to fracture the seam allowing release of the heating gas and water vapor once the deposit location is heated to their evaporation temperatures and passage in the Nitrogen gas carrier to the drill location for drawing it up to the surface. This will make the fuel and water resources available for present extraction increasing the overall active oil reserves to include previously “useless” territories. The peripheral insertion of the Nitrogen provides the inert carrier gas to transport the evaporated heating gases and water and provides fire protection preventing flash fire in the deposit. In the cases of shale seams, the depth of seam is accommodated by the layering of zones. In the case of organic pollutants in the ground at designated superfund sites, brownfields and leaking underground storage tanks and the equivalent, this system applies as defined.

Some of this technology applies as well to coal, shale, peat and landfill seams.

2. Discussion of the Related Art

Patent application serial numbers of Denyse DuBrucq, Liquid Nitrogen Enabler, Ser. No. 11/706,723 section for coal mine fire control and condenser methods and Liquid Nitrogen Enabler Apparatus, Ser. No. 11/750,149 for the related apparatus. Similar methods are employed here for fire prevention, for the separator or condenser, and for providing the Nitrogen carrier gas for the evaporated organics in coal, shale, peat and landfill layers.

Aspects of this discovery apply to the earlier filed Nitrogen patent technology of inventor, Denyse DuBrucq, especially Hydrocarbon Harvesting from Coal, Shale, Peat, and Landfill Seams, application Ser. No. 11/903,346, filed Sep. 21, 2007. Oil Shale has extended height and extraction seams are created, as described for Methane hydrate deposits, to layer extraction zones to do the fill site resource in manageable segments.

Searching the patent literature brought no published patents and only three applications using Liquid Nitrogen in the extraction of fuel from Methane hydrate. All used the Liquid Nitrogen to liquefy resulting product as Petru Baciu's liquefying Methane in Application 20050072301, Procedure and apparatus for collection of free methane gas from sea bottom. Wendy L. Mao and Ho-Kwang Mao in 20030089117, use Liquid Nitrogen in the storage of Hydrogen, and John Lee Edwards in 20070270512 lists it as an alternative to condense methane but claims the way to provide fuel from the Methane hydrate is to oxidize the Methane into Methanol. No issued patents claim Liquid Nitrogen in Methane hydrate extractions. The search was done Jul. 3, 2008.

Successful extraction of fuels from Methane hydrate deposits in Canada has been obtained by injecting hot water into the deposit. “With a maximum content of 164 m³ of methane and 0.8 m³ of water at standard temperature and pressure per cubic meter of hydrate and an estimated range of 26 to 139×1015 m³ globally, this is a significant new energy source. The content of methane in hydrates is variable and is controlled by geothermal gradients and biological methane production.” From article Ocean Floor Methane Gas Hydrate Exploration by R. B. Coffin etc. As liquids, Methane hydrate is 80% water and 20% Methane. Evaporating at standard pressure and temperature, Methane expands 820 times in volume.

From literature, the methane and related pure hydrocarbons are formed by anaerobic consumption of Oxygen and other minerals from the hydrocarbon residue from plants and animals leaving the often cracked carbon chain to small atom molecules of carbon and hydrogen. Water at high pressure as is found a depths of 300 meters or below in the sea forms a shell around a single Methane or other . . . ane molecule and it accumulates forming a very impermeable white “burnable ice.” It is often found in clay deposits making the extraction more difficult, though some is in sand deposits. Over time, these deposits have accumulated a surface cover, which will be advantageous in this fuel extraction method.

Methane is an explosive gas. Therefore carrying it from the deposit to the surface in fire suppressant, inert Nitrogen gas, will make extraction safe and preserve the purity of the chemicals emerging from the deep ocean environments. Previous attempts at hot water extraction have been successful on a small scale. The water adds to the hydrate component of the material and can bring contaminants. Using Nitrogen gas extraction limits water amounts to the deep sea hydrate component and is separable from the hydrocarbon in the new process as described in DuBrucq application Ser. No. 11/903,346.

### SUMMARY OF THE INVENTION

In accordance with one aspect of the invention, the method of drilling into the Methane hydrate deposits to extract fuel gas and water fractions allows extraction from one drilling should pull organics and fresh water from a fifty foot square by the height of the deposit or more depending in part by the strength of the cover substance.

In another aspect of the present invention, the drilling process using a hammer drill with pneumatic retraction, providing pure Nitrogen gas as the compressed air needed infiltrates the fuel seam with Nitrogen beginning the Nitrogen saturation process.

In another aspect of the present invention, the first event in extraction is to freeze solid the site of the main drilling to make the seam rock or hydrate brittle cold and crack it by vibration, if it is found to be helpful in extracting the fuel gas and water. This process may alter the Methane hydrate configuration freezing the water which would release the Methane gas. Were this the case, less water would need to be condensed from the extracted fuel and the temperature of the extraction zone could be considerably lower.

In another aspect of the present invention, the method places a contained heat source into the Methane hydrate deposit heating it to evaporate the fuel gases and water trapped underground or underwater. To safely carry these organic gases to the surface, the pure Nitrogen gas flows from the organ pipes or reed sound source passing into the heated area and emerges from the depths through an inverted funnel mixed with and carrying the fuel gases and water from the depth of the drilling to the ground surface or platform at sea.

In accordance with another aspect of the present invention, the method of using pure Nitrogen gas as the carrier prevents fires because it lowers Oxygen levels in the gas mixture as fuel is heated above water evaporation temperatures and the flash point of Methane gas and must be driven to the surface without ignition.

In accordance with another aspect of the present invention, once at the surface, the method carries the hot gas mixture towards the Liquid Nitrogen source with carrier pipes in proximity which liquefies the water at one temperature and the fuel gases at other temperatures and locations along the pipe. The remaining Nitrogen and Rare Gas mixture allows condensation of Oxygen and Argon and vertical passage of Hydrogen, Helium and Neon and captures them in Mylar balloons or compressed gas cylinders for separation later. The Nitrogen release location provides pure Nitrogen gas for the compressor for use in the pneumatic hammer drill, for a Nitrogen liquefier and the remainder is released into the air over a mixing fan to insure the Nitrogen does not remain pure in clouds, rather mixes it to near 78% of atmospheric gases which is the portion of dry air it naturally occupies.

In accordance with another aspect of the present invention, the fractions of the extracted hydrocarbon materials are separated in collection and can be contained in pressure tanks or as a liquid in cryogenically cooled, using Liquid Nitrogen, tanks for market as refined heating gases giving top price levels of fuel gas. Any long carbon fuels that emerge are collected in their fractions in barrels.

In accordance with another aspect of the present invention, this method expands the field of extraction by drilling narrow peripheral holes to apply Liquid Nitrogen as used in putting out coal mine fires. This provides fire suppressant carrier for the evaporating water and Methane gas carrying it to the center extraction drilling. The Nitrogen flooding also reduces the opportunity for fires or flashes during extraction. Use of Liquid Nitrogen at −195.8° C., causes liquids to freeze protecting the extraction zone from external invasion by sea water or Methane hydrate release icing the outer periphery and releasing Methane gas to be carried in Nitrogen to the extraction pipe.

In accordance with another aspect of the present invention, once the extraction is exhausted in the space served by the first ring of narrow drillings, another ring of narrow drillings away from the extraction hole are made and these holes provide the Liquid Nitrogen application as did the first narrow holes drilled. The first narrow holes are then converted to supplemental heating locations having narrow heaters inserted in the holes at the Methane hydrate depths and inserting thermal insulation between the sea bottom and the top of the Methane hydrate deposit. Again the peripheral sourced Nitrogen gas carries melted water and evaporated Methane departing the extraction zone through the funnel and piping in the main hole.

In accordance with another aspect of the present invention, the field of extraction is expanded by drilling additional rings of narrow drillings where Liquid Nitrogen is inserted in the most distant holes and the inner holes are converted to auxiliary heating locations to keep the water and heating gases gaseous and moving to the main drilling by the Nitrogen inserted at the outer ring. This convection carriage of the heating gas and water evacuates the Methane hydrate deposit leaving a void at high pressure due to the depth of these types of deposits.

In accordance with another aspect of the present invention, to prevent ending the extraction process because of collapse of the void created by continued extraction, a series of ring supported expandable tubes strengthened like windpipe structure in man and other mammals is inserted to carry the evaporants from the periphery to the extraction drilling. These are inserted through the surface into the void as it approaches ten cubic feet of void. Eight units with branching tubes to accommodate the planned number of narrow drillings for ring expansions are inserted through a sequence of doors to preserve the closed nature of the extraction field with specific robots which assemble the system and during the continued extraction push the tube sections into the newly evaporated spaces. The eight units allow for a square nine unit matrix and the tube expansions expand that to a 25 unit matrix, then a 49 unit matrix and 81, 121, and 169 unit matrices on to the limits of the planned extraction zone.

In accordance with another aspect of the present invention, this full system, when the limits of the planned extraction zone are void from evaporating the contents, the whole structure except for the tubes and robots in the deposit void, can be removed and repositioned in another section of the Methane hydrate deposit to extract the same size space. This new location can be elsewhere or be just below the just completed extraction zone. In the case of deep seams, the first extraction zone can be up to three meters, and, with extraction completed, the main hole can be extended to the next three meters and the process begin again making a stack of layers of extraction zones to whatever depth is possible or thought profitable. Collapse of upper expired zones should not hinder this expansion of extraction downward in the deep sea. Applying this practice to oil shale, another deep fuel source, the remaining residual shale less the extracted fuel should hold the sequence of exhausted seems stable since their dimension doesn't change significantly.

In accordance with another aspect of the present invention, this method will be ecologically an improvement over current mining and petroleum and natural gas extraction methods because these deposits are of common material, water and Methane, with possible inclusion of molecules as large as Ethane and Propane allowing taking the pure evaporated heating gas type and directly bottling it without oxidizing it in the process, and only releasing pure Nitrogen gas from the process, and requiring no externally acquired water use in the processing.

In accordance with another aspect of the present invention, because the deposits are so far below the surface of the ground or sea, it does not matter if the underground structure ruptures as the space of the deposit is voided since the tubes carry the Nitrogen, water and fuel gases to the extraction tube at the center of the selected deposit area.

In accordance with another aspect of the present invention, this method will allow on platform or extraction site use of the fuel gas by placing major electrical generators on the platform burning all or some of the gas (bottling the remaining amount) to generate electricity. This electricity could be carried to populated areas by an undersea cable if at sea and by a high tension wire if on land.

In accordance with another aspect of the present invention, this method captures eighty percent of the extraction volume in pure distilled water which can be sent by pipeline to population centers as a source of fresh water. An alternative to delivering bottled gases, a power generator can be installed on the platform or land over the extraction zone and electric power and fresh, distilled water are cabled and piped to use sites as a single bundle.

In accordance with another aspect of the present invention, this method will allow capture of the rare gases, helium, neon and hydrogen for later separation if present. The pure Nitrogen gas can be compressed and used with the pneumatic drill rather than compressed air saturating the extraction zone with Nitrogen from the start. And, with the power available, a Nitrogen liquefier can be installed on the platform using the flow of pure Nitrogen gas from the condensing process eliminating the air separation process.

In yet another aspect of the invention, the entire system can be applied to the close to the surface of the ground extraction of organic pollutants in Superfund sites, brownfields, and leaking underground storage tanks and the equivalent caused by spills, ignorant disposal of organics, accidents, naturally cause release of chemicals or war time operations. Modest accommodations as surface thermal insulation of the extraction zones and modifying the condensing system to isolate and extract the specific targeted pollutants and quantifying the amount removed are needed. Further variance includes often extracting from an aquifer layer which does not change the process, but will freeze the aquifer contents and draw to the surface more water at distilled water, possibly with organics that condense at temperatures close to the boiling point of water.

And in still another aspect of the invention, dealing with layers of water, be they open caves or rocks porous and allowing water passage, to insure the extraction gases are not leaked beyond the extraction zone and to secure performance of these levels are similar to other solid material levels, water can be drawn from heated areas by a sump pump and released inside the cold zone spraying it such that a full ice barricade forms sealing the extraction zone at the levels of the aquifer or other layers of porous rock.

These and other advantages and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout, and in which:

FIG. 1 shows both the preparatory cryogenic freezing of the Methane hydrate deposit in FIG. 1a and the vibrational cracking of the deposit material in FIG. 1b.

FIG. 2 is a drawing showing the overall drill hole from the surface of the ground or sea to the Methane hydrate deposit with components of the heater, tonal input, Nitrogen and the extraction tube shown complete vertically, and partially above the ground surface.

FIG. 3 is a drawing showing the surface equipment with a power source for the heating unit, a lever to tune one of the organ pipes, Nitrogen sourcing through a condenser which is fed with Liquid Nitrogen from a large thermally insulated tank.

FIG. 4 is a drawing better defining the extraction tube condenser of the extracted organics where the segments of the evaporant condenses as the temperature lowers and the Nitrogen warms up while condensing the evaporants. The major fractions of Petroleum are drawn out of the condensing tube with drain type trapped piping.

FIG. 5 is a drawing showing the containment of the fractions of the extracted water and heating gases for collection, bottling and taking to market. Also shown is the Liquid Nitrogen storage and feeding into the condenser which cools the extracted gases and water vapor and eventually supplies the organ pipes with pure Nitrogen gas, and upon ending the condensing process, the pure Nitrogen is compressed for use in drilling or re-liquefied to continue the process without outside Liquid Nitrogen suppliers.

FIG. 6 is a drawing showing the cross-sections of the condensing tube with the cold Nitrogen gas cooling the extraction tube so as to condense the water and pure hydrocarbons on a thermal gradient into water and increasingly smaller carbon chain molecules.

FIG. 7 is a drawing showing more detail in the condensing tubes with depressions to direct flow into the drains, a stopping means to keep fuel fractions flowing to correct drain holes, and a series of thermisters allowing temperature monitoring, keying changes needed in placement of the barriers between fuel fraction condensations.

FIG. 8 is a diagram showing in FIG. 8a placement of cooling holes where Nitrogen gas is inserted carrying evaporants to the main hole and icing the outer reaches of the extraction zone; and in FIG. 8b further auxiliary hole drilling allowing the original holes to be fitted with heaters to evaporate the fuels and the outer holes for Nitrogen supply and icing the far reaches of the extraction.

FIG. 9 shows inserts that can be placed where collapse of the extracted area might happen which facilitates carriage of the evaporated fuel, water and Nitrogen gas to the main hole for extraction, including in FIG. 9a a top view of the first expansion to auxiliary heated areas; in FIG. 9b a cross section of the insert components that can implement two extensions as shown in FIG. 9c in top view; and in FIG. 9d cross section of insert components that allow three expansions as shown, top view, in FIG. 9e.

FIG. 10 is a drawing of the Liquid Nitrogen containers slow flowing into a cup, FIG. 10a, which when full, empties, in FIG. 10b, into the sieve which disperses drops which evaporate into Nitrogen gas when falling cooling the target area and providing the carrier gas for fuel and water, carrying them to the main hole for extraction. FIG. 10c shows a heavy metal transport dewar that can take Liquid Nitrogen from platform on the surface to the deep sea position of the new main shaft or outer auxiliary hole series, and FIG. 10d its change when encountering the dispensing dewar as seen in FIG. 10e.

FIG. 11 is a side view drawing of extraction zone expansion where the first drillings had the Liquid Nitrogen treatment, but are now fitted with heaters which heat the expanding extraction into the deposit in inner ring of narrow drillings.

FIG. 12 is a drawing of heater designs, with FIG. 12a and FIG. 12b showing the cross section and top view of the main drilling heating unit and with FIG. 12c and FIG. 12d showing those aspects for the auxiliary hole heating units.

FIG. 13 shows in FIG. 13a means to collect the very light gases, Hydrogen, Helium and Neon, whereby as in FIG. 13b the gases raise a near weightless inverted tube which is emptied into a mylar balloon by pressing it down with exit to balloon, FIG. 13c.

FIG. 14 shows the light gasoline/water catch where FIG. 14a shows the outer structure, FIG. 14b shows the side view inner structure separating the water from gasoline using the multi-holed separation float, heavier than water, lighter than gasoline, keeping the interface of the liquids inside tubular holes to preserve separation, FIG. 14c.

FIG. 15 shows the distribution of Liquid Nitrogen having the outflow into the condensation tube to feed the main hole and then to the auxiliary holes as area expands.

FIG. 16 is an annotated image of the condensation region of the extraction system showing the fractionation of the extracted fuels and other gases including releasing the expended Nitrogen both into the compressor for use in pneumatic drilling and free in the environment with a fan mixing the air with the Nitrogen to prevent Nitrogen clouding.

FIG. 17 shows the extraction system for Methane hydrate including the main hole and condenser system, and puts the pure Nitrogen into a Nitrogen liquefier and the fuel gases and Oxygen into a natural gas power generating plant, all possible on the platform.

FIG. 18 depicts the difference in Liquid Nitrogen delivery, FIG. 18a, for the auxiliary hole icing and Nitrogen infusion deep in the sea where the Liquid Nitrogen is dropped to the seam level before passing through the sieve to evaporate, and FIG. 18b for quick Nitrogen gas generation in everything from the cooling tubes in dam and dike repair to the evaporation units in the start of the Nitrogen flow in the condenser systems. FIG. 18c shows Liquid Nitrogen entry into the condenser with sieve imbedded in the initial unit causing the Liquid Nitrogen rain to evaporate into Nitrogen gas.

FIG. 19 shows the pneumatic drilling rig for providing the holes using, in place of compressed air, compressed Nitrogen gas collected from the exhaust from the condenser system. This provides the initial Nitrogen saturation pushing Nitrogen into the rock or hydrate as the holes are drilled and the compressed air starts the drill bit upward.

FIG. 20 shows side view of a fully extracted seam or layer of a seam of fuel impacted rock, coal, shale, or an emptied Methane hydrate deposit.

FIG. 21 shows side view of the fully extracted layer of a seam with a second extraction layer being started, and, note, the outer auxiliary hole ring stays cold so ice prevents invasion of the extraction zone by ground water or sea water or other material.

FIG. 22 shows a full system of layered extraction zones with neighboring stacks of extraction zones and “common” outer freeze zones. This could cover ten acres with eight fifteen foot zones giving a volume 67,500 cubic feet extracted of its fuel content.

FIG. 23 provides thermal definition in color coding of the components of the fuel extraction system including defining the extraction zone temperatures with two sets of auxiliary drillings, the inner one with the heater and the outer with Liquid Nitrogen sourced Nitrogen cooling. Specific for Methane hydrate, were a battle ship used as the platform, it would support use of fuel gases to power an electrical generating plant supplemented by the Oxygen extracted and isolated to enhance the burn temperatures and, because of the remote location, its own Nitrogen liquefier using the exhaust Nitrogen from the condenser since the contaminating materials are all frozen out of the Nitrogen or removed as super light gas—Hydrogen, Helium and Neon. Note that wherever the pipe location, the thermal variation is minimal over time, excepting for startup and shut down.

FIG. 24 provides means of thermally insulating the surface of an extraction zone for removing pollutants from the ground and detailing the condensing of specifically targeted pollutants from other classes of extract ants in the harvesting process.

FIG. 25 shows the means used to seal the extraction zone by building up ice in the freeze zone sealing the zone from top to bottom of these aquifer and other layers.

### DETAILED DESCRIPTION OF THE PREFERRED EMBODIMENTS

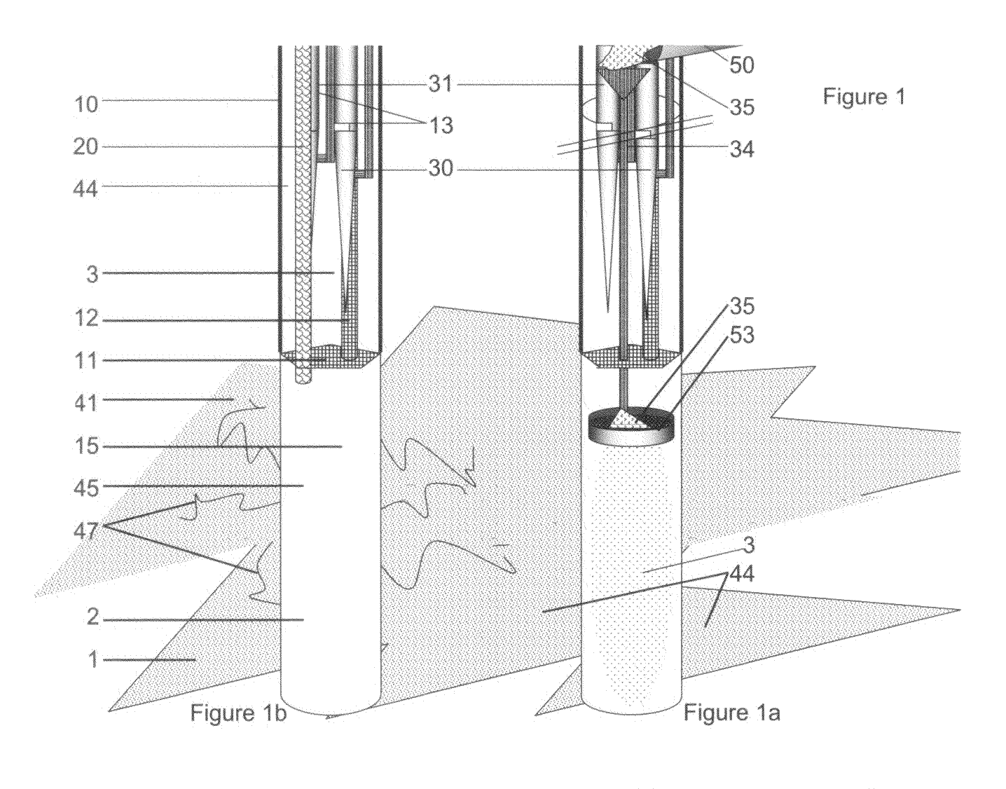

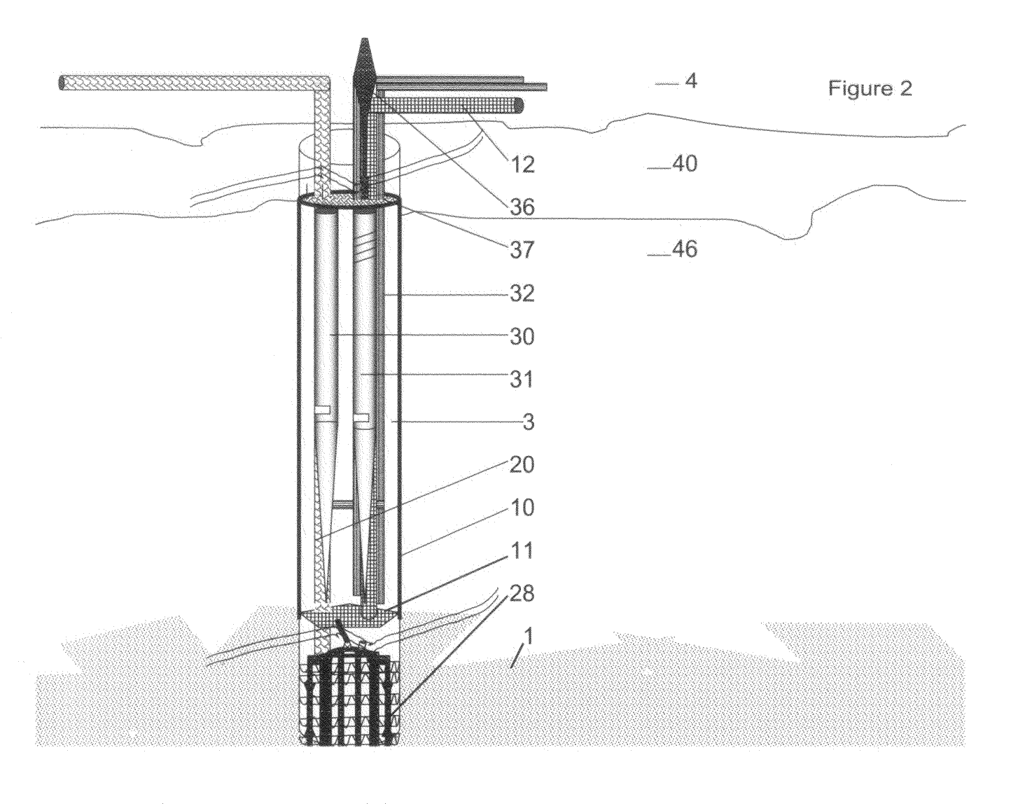

Turning now to the drawings and initially to FIGS. 1-2, showing the center, lower section and top of the drill hole for extracting fuel hydrocarbons from Methane hydrate. In FIG. 1, the Methane hydrate deposit 1 is cooled with evaporating Liquid Nitrogen to brittle cold in FIG. 1a, and then vibrated with sound at both the frequency of the standard organ pipe 30 and the frequency difference beats created by the adjustable frequency organ pipe 31 that can vary widely with the tuning of the adjustable pipe in FIG. 1b. The purpose of this ground stimulation is break up the seam structure when brittle cold, and then continued through the heating phase FIG. 2 to get air throughout the deposit 1 such that the heat evaporated Methane and water escape the structure of the deposit. If the initial cold separates Methane from water, the water will freeze providing the ice encirclement and the Methane will be drawn with the Nitrogen.

FIG. 1 shows both the preparatory cryogenic freezing of the Methane hydrate seam and the initial configuration of the extraction hardware. FIG. la shows the drilled hole with the organ pipes in place and a sieve pan 53 mounted at the upper level of the seam. The Liquid Nitrogen 35 is poured from a dewar 50 down the Liquid Nitrogen pipe 61 and emptying into the sieve pan causing the Liquid Nitrogen 35 to evaporate into super cold Nitrogen gas 3. In FIG. 1b, when this cool zone 44 reaches cryogenic temperatures, the organ pipes are activated causing the brittle cold seam to shatter, which allows the hydrocarbons to escape once the heating process begins. Using this method with shale, the water embedded in the layered rock expands when frozen and the kerogen will ball displacing it, partially at least, from the adherence to the rock layers. Upon melting, the rock is relieved of strain from the ice, but opened and as the heat exceeds 300° C., the kerogen separates into lower carbon compounds and evaporates escaping.

FIG. 2 shows the lower part of the drilling gauging better the distance at the bottom of the drilling where the heating of the reserve occurs making volatile organics evaporate and escape to the drilling location. The funnel catches the pressured Nitrogen and evaporants, which are drawn into a well-insulated vertical pipe, which once at the surface bends horizontally to enter the condensing system. Illustrating the lower portion of the shaft 10 has the heat energy source 20 passing down through the funnel 11 and the heating element 2 which heats the Methane hydrate seam 1. Convection in the shaft 10 forces the pressure imposed Nitrogen 3 activating the organ pipes and allows it to flow around the gaps between the funnel 11 and the walls of the shaft. Evaporated hydrocarbons 15 and water from the seams 1 mix with the Nitrogen gas and are taken out of the shaft via the gaseous escape pipe 12 which allows the hot gases rising with the heat out of the vertical shaft. The evaporants 15 in the seams 1 escape the seam as the tonal output of the organ pipes cause the seam structure to vibrate.

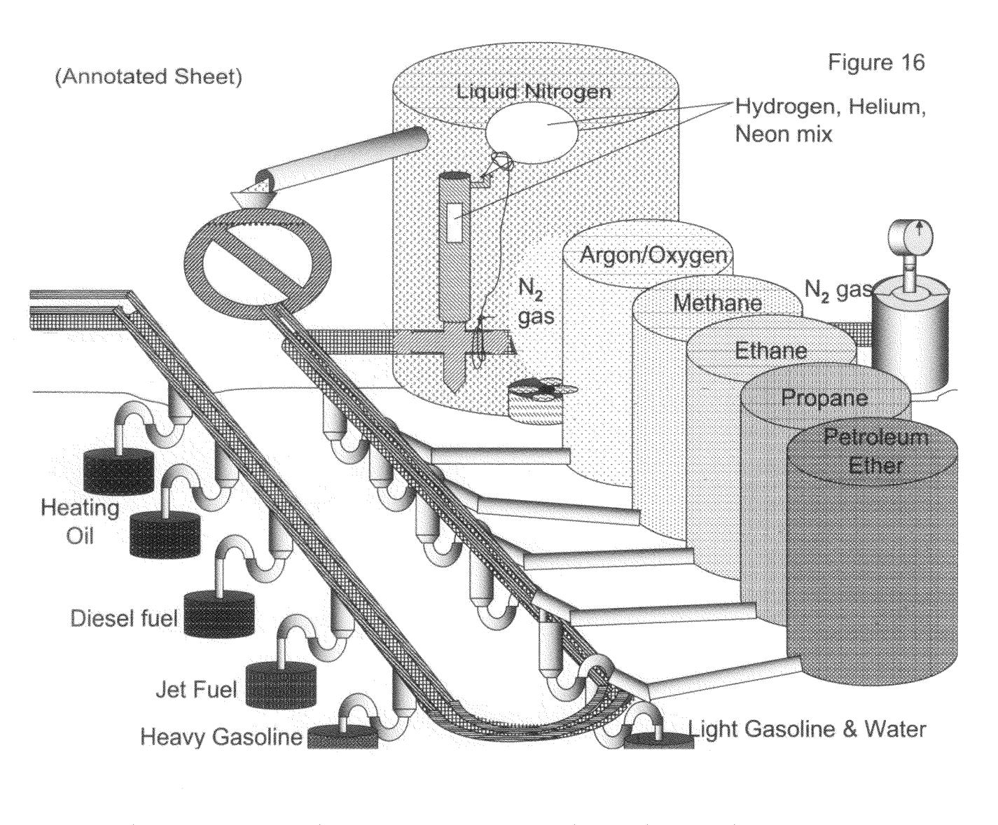

It is this section of the drilling that will initially be frozen to brittle coldness with evaporating Liquid Nitrogen applied through a sieve described in Liquid Nitrogen Enabler patents of DuBrucq (Ser. Nos. 11/704,723 and 11/750,149) where the funnel 11 is located. Liquid Nitrogen is poured down the drilling and at the sieve will rain down in the lower end of the drilling cooling the seam closer and closer to its −195.8° C. evaporating temperature. Once brittle cold, the sieve is removed and the heaters 2 as shown in FIG. 16, the funnel 11 and exhaust tube 12 are installed with the pipes 30, 31 to cause vibration while the seam is still brittle and then to do so as the heat extracts the hydrocarbons with Nitrogen gas carrier to clear their pathway to the exhaust tube 12.

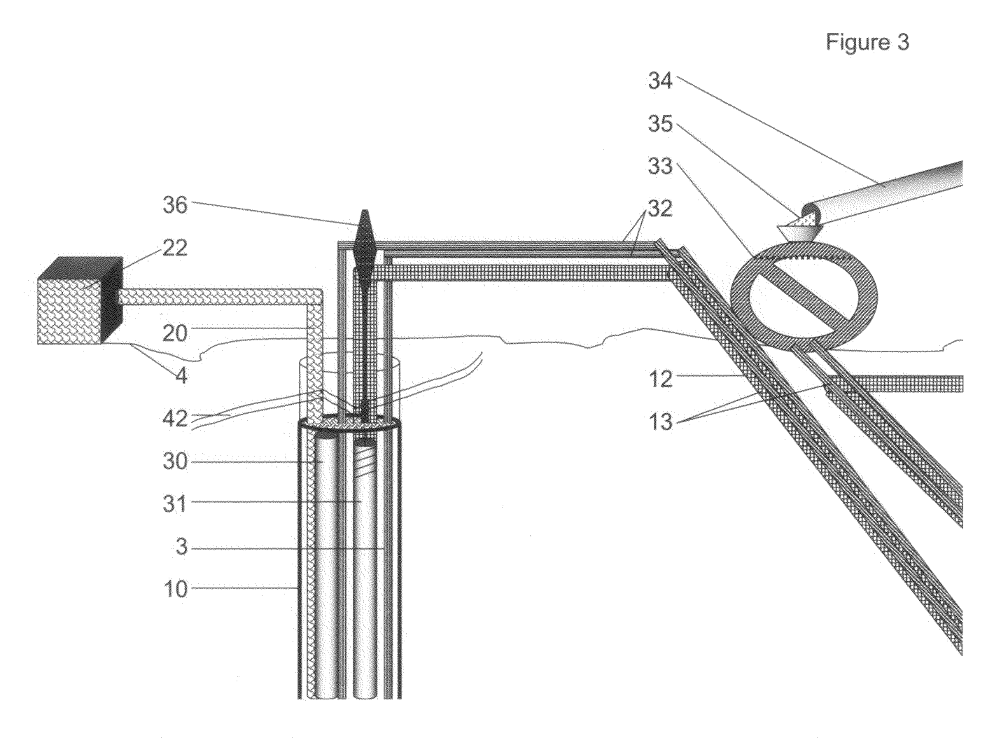

FIG. 3 presents the top of the shaft 10 showing the ground level 4 and a space 42 indicating the workings of the shaft contents can be well below the surface of the ground or deep in the ocean. The power source for the heater 22 is on the ground powering the heat energy source 20 which passes down to the bottom of the shaft. The tonal adjustment 36 for the adjustable tone organ pipe 31 sticks up so it can be controlled from the top of the shaft or remotely controlled from the surface. The Nitrogen pipes 32, one for each organ pipe 30, 31 get their Nitrogen 3 from the condenser 33 where Liquid Nitrogen 35 is evaporated into Nitrogen gas and passes through the Condenser 13, which heats the Nitrogen before entering the shaft. The gaseous escape pipe 12 comes up the shaft and passes under the Nitrogen pipes 32.

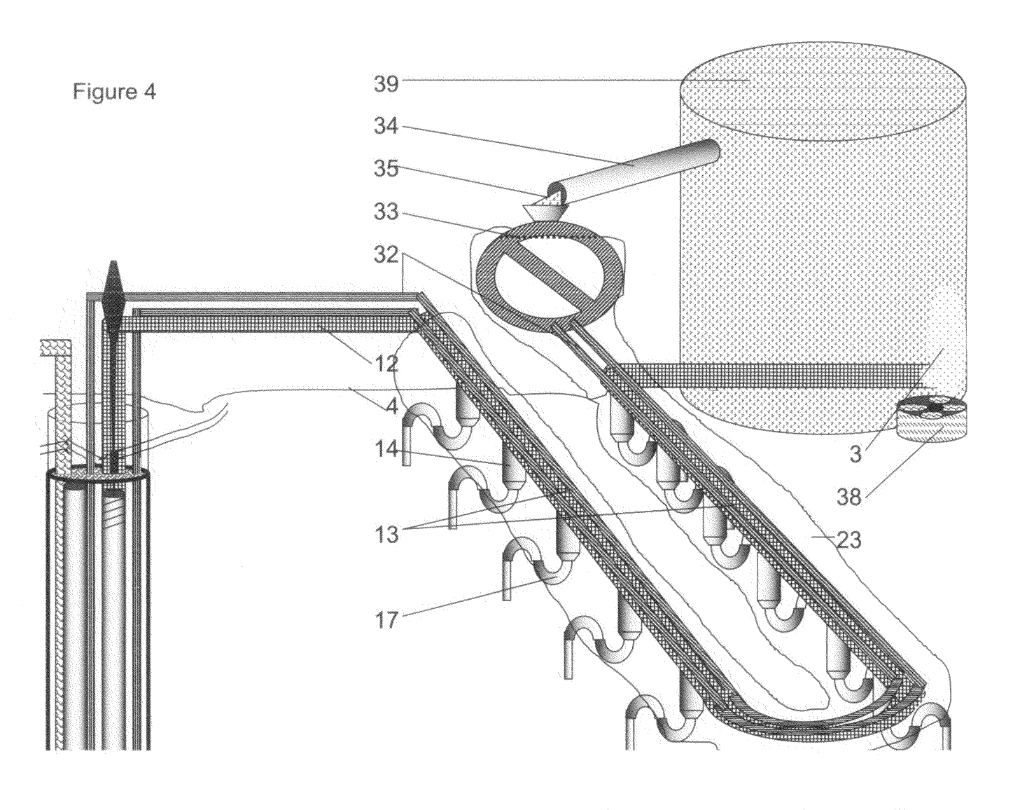

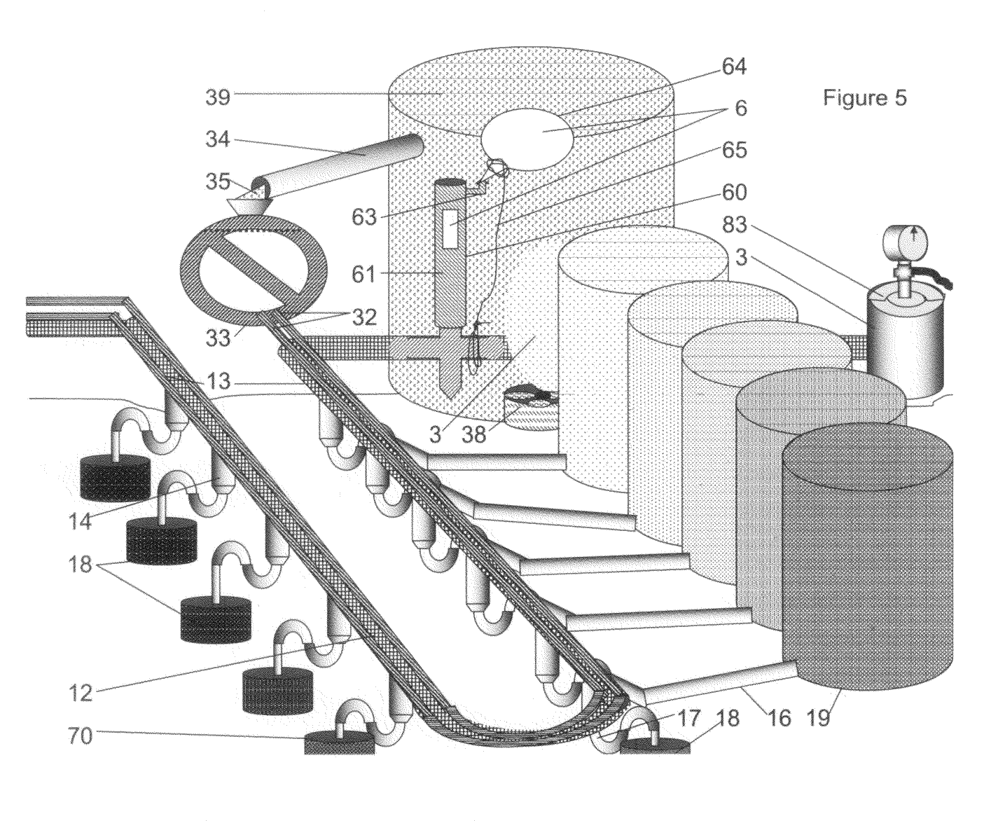

FIG. 4 elaborates on the condenser 13 showing the gaseous escape pipe 12 coming from the shaft. The tank of Liquid Nitrogen 39 feeds Liquid Nitrogen 35 down the Liquid Nitrogen pipe 34 and into the condenser 33 which is insulated 23 throughout the condenser 13 providing cooling for the evaporated hydrocarbon/Nitrogen mix 15 coming through the gaseous escape pipe 12. The coldest Nitrogen cools the last, low carbon chain hydrocarbons left in the gaseous escape pipe 12. As the Nitrogen gas warms, it condenses the longer carbon chain hydrocarbons to where the longest as collected in the condenser 13 closest to the shaft 10. To separate the Kerosene from the gasoline and petroleum ethers and fuel gases segment output pipes 14 draw the condensed hydrocarbons in sections of the pipe 12. These liquids pass through the trap 17 and go to storage shown in FIG. 5. The final output of the gaseous escape pipe 12 is the Nitrogen gas 3 left in the pipe which is dispersed being mixed with air by a fan 38.

For safety and to prevent clouding of pure Nitrogen 3, a fan 38 is employed to mix the Nitrogen with the residual air so there is no opportunity for people or animals to develop Nitrogen Asphyxiation or Nitrogen Coma, a reflex of the lungs when Oxygen is not available and Carbon dioxide cannot be exchanged in the lungs. Breathing stops, but the heart keeps pumping and one loses consciousness. There are about six minutes from when one is so stricken until he or she or an animal would die. With these Nitrogen employing methods, one should be aware of the possibility of this condition and, if finding a person down, one should think first to apply artificial respiration with a good mix of air present and, if the person recovers, all is well. If he or she does not recover, then call 911 and do the CPR-type work to recover a person from a heart attack. And if that fails, check for stroke or other difficulties. Shortly the medics will arrive.

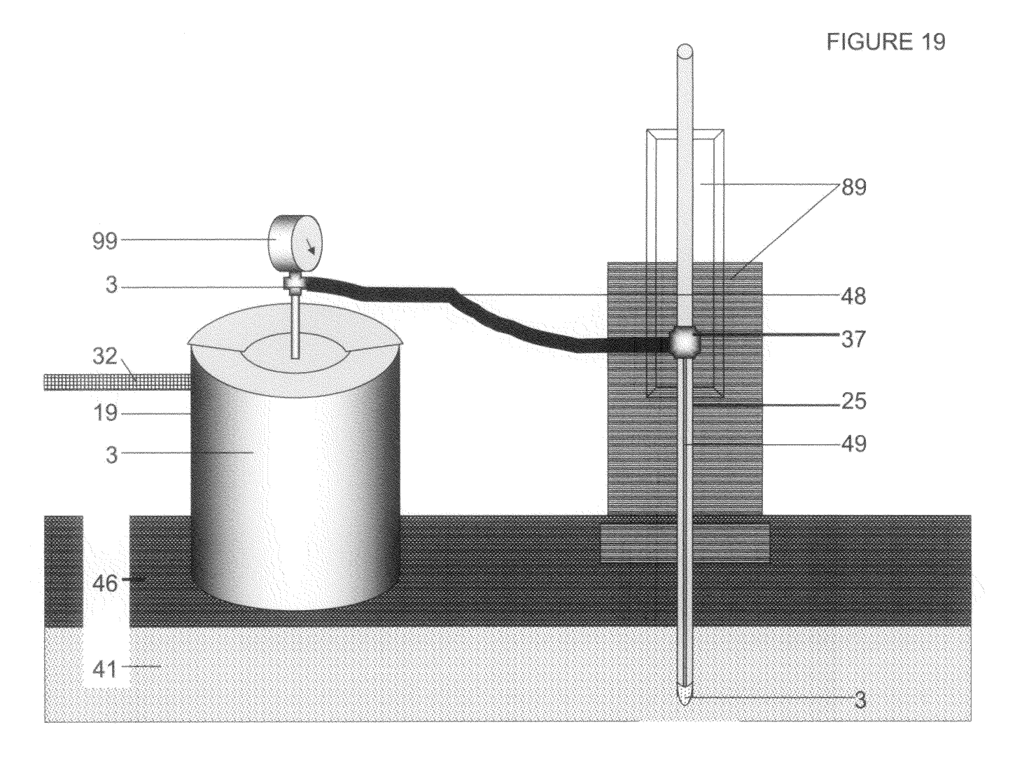

FIG. 5 completes the condenser apparatus by having the segment output 14 and trap 17 allow the condensed liquids to flow into containers 18 if the hydrocarbon is liquid at ambient temperatures or gas drums 19 if the hydrocarbon fraction is a gas. The gas drums 19 are fed with an outsource pipeline 16. The final separation 60 in the sequence is collection of the rare gas segment—Hydrogen, Helium and Neon—light weight gases 6 collected in an inverted container 61 and drawn off through the extraction tube 63 into a mylar balloon 64 held to the ground with a tether line 65. It also shows the remaining gas in the gaseous escape pipe 12 passing the remaining pure Nitrogen gas 3 to the compressor 83 which will provide the compressed Nitrogen gas to the pneumatic hammer drill which creates the main and auxiliary holes. Nitrogen feeding the drill is illustrated in FIG. 19. Also defined is the cold source for condensing the hydrocarbons with the tank of Liquid Nitrogen 39 feeding through a pipe 34 Liquid Nitrogen 35 into the condenser 33 which feeds its cold Nitrogen gas 3 into the Nitrogen pipes 32 that cool the gaseous. escape pipe 12 as it enters the condenser 13.

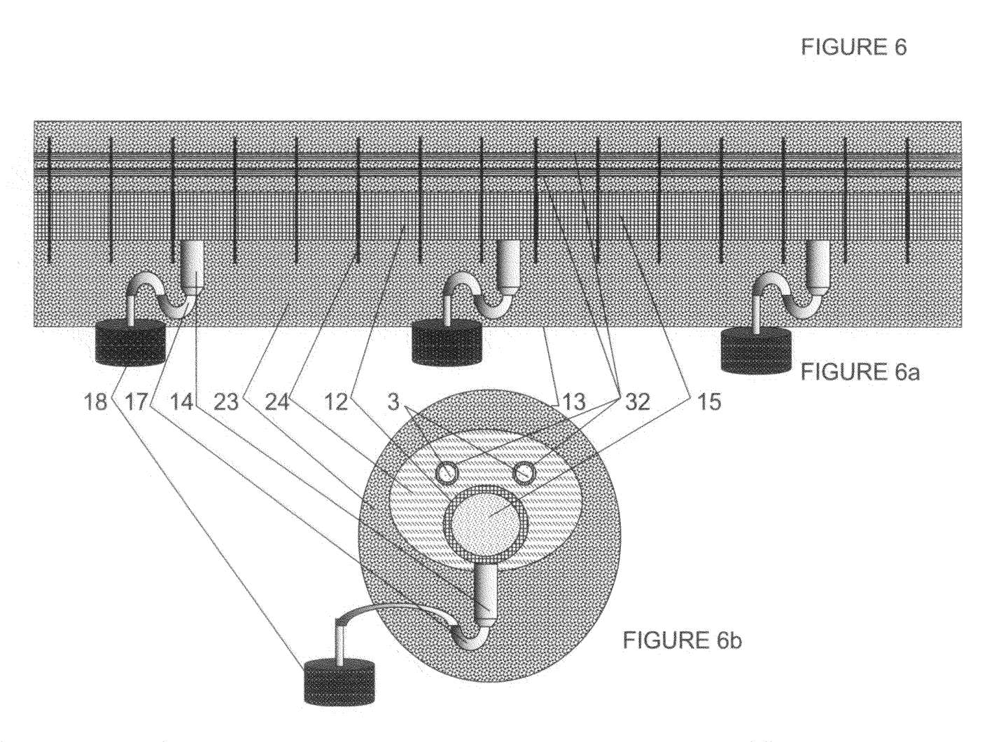

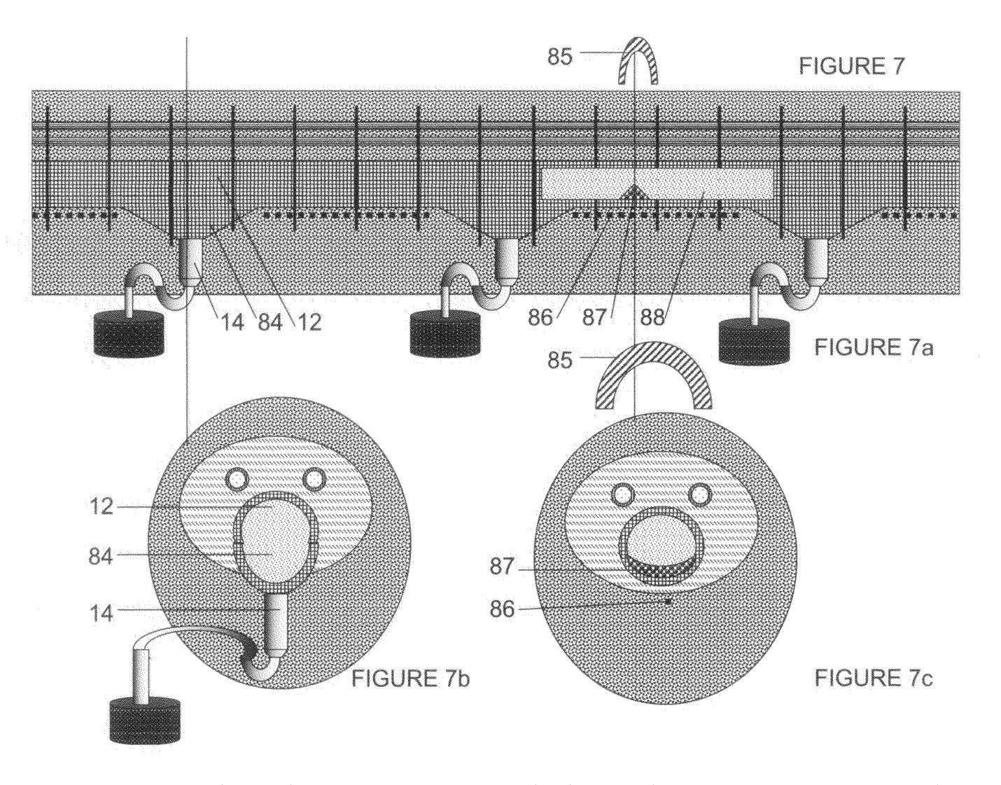

FIG. 6-7 define the condensing system 13 structure with the insulated cover 23 enclosing the Nitrogen pipes 32 carrying the warming Nitrogen gas 3 to the shaft. Radiator tabs 24 transfer the cold from the Nitrogen pipes 32 to the gaseous escape pipe 12 carrying the Hydrocarbon/Nitrogen mix 15. As the mix is cooled, first the high number carbon molecules condense and the liquid runs into the segment output 14 and through the trap 17 and into the container 18. Viewing the containers 18 in FIG. 6A, the patterns indicate lighter and lighter condensation coming into the containers at each segment output 14. The gas contents of the pipes defined in FIG. 6B are included but not shown in FIG. 6A. Major fractions of petroleum assumed to be included in the extractions from the drilling include from heaviest to lightest: Heating oil with boiling (condensing) points between 275-375° C.; Kerosene between 175-275° C.; Gasoline between 40-200° C.; Petroleum ether between 30-60° C.; and Fuel gas at −162-+30° C. Fortunately, Liquid Nitrogen evaporates at −195.8° C. so even the Methane Gas can be captured which condenses at −162° C. In the Methane hydrate deposits, most of the evaporants will be fresh, distilled water and the light heating gases.

Refining the system, FIG. 7 shows that the condensation pipe 13 dips 84 towards the drain areas 14 and has flow barriers 87 at the thermal cut off points for each fuel fraction. Temperature of the condenser is determined by thermisters 86 which indicate. where the fuel fraction limits are at the time so the 87 barrier, a sack of iron balls shown in the cut away 88, can be moved manually with a magnet 85, or automated.

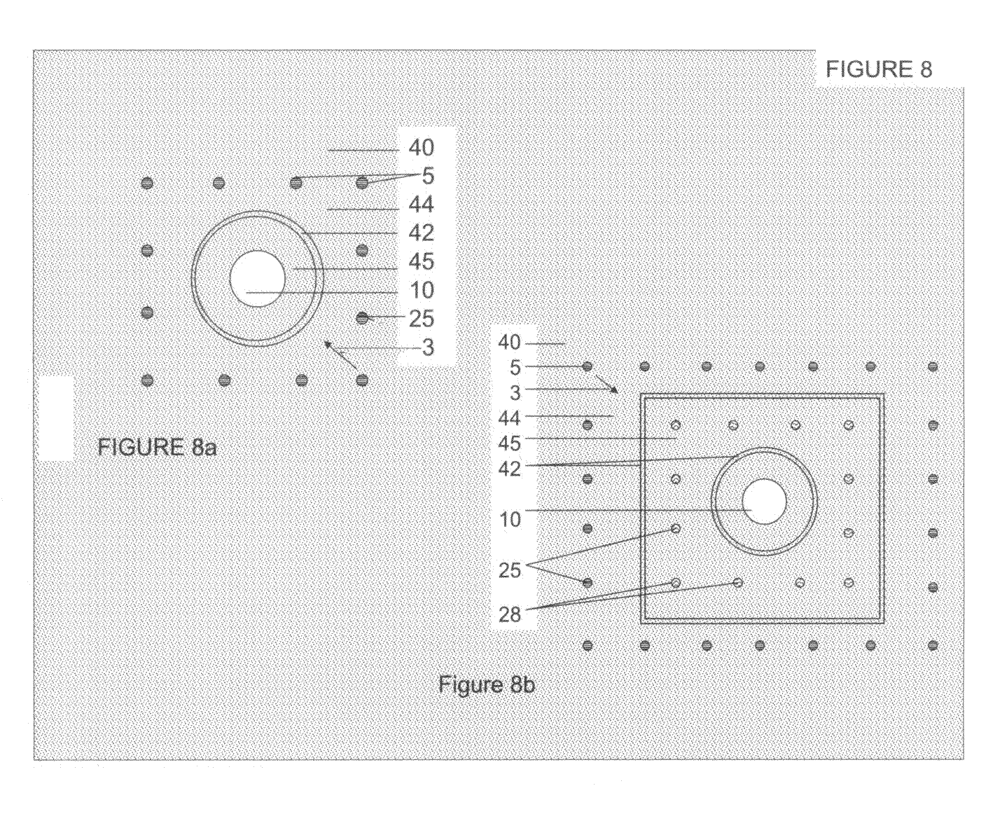

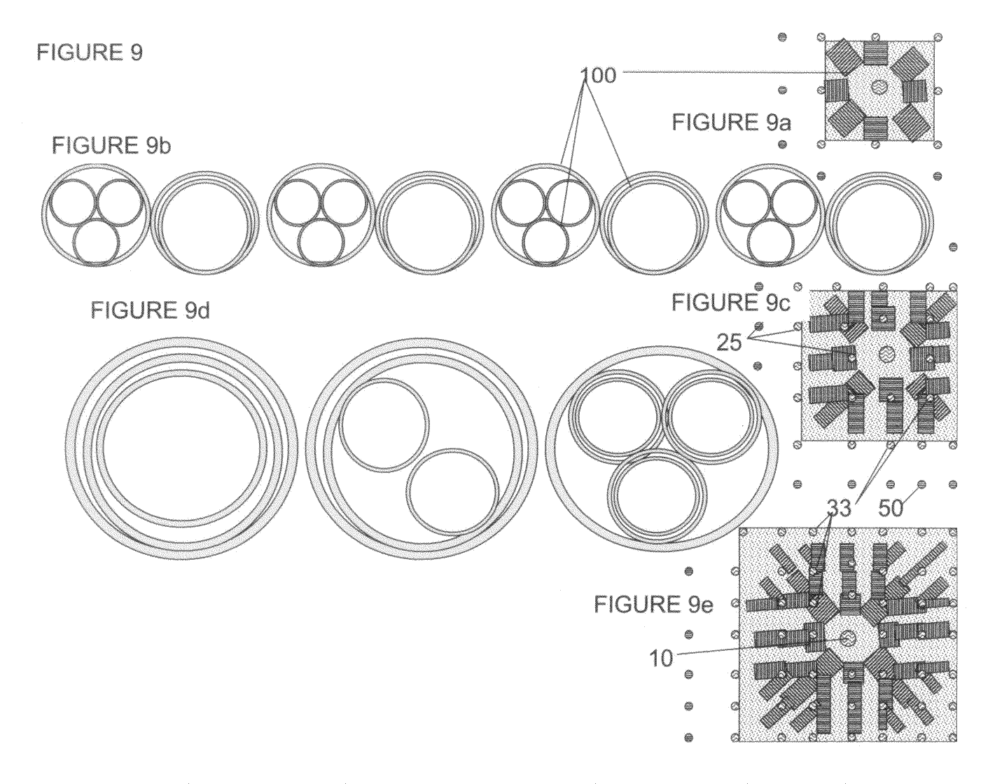

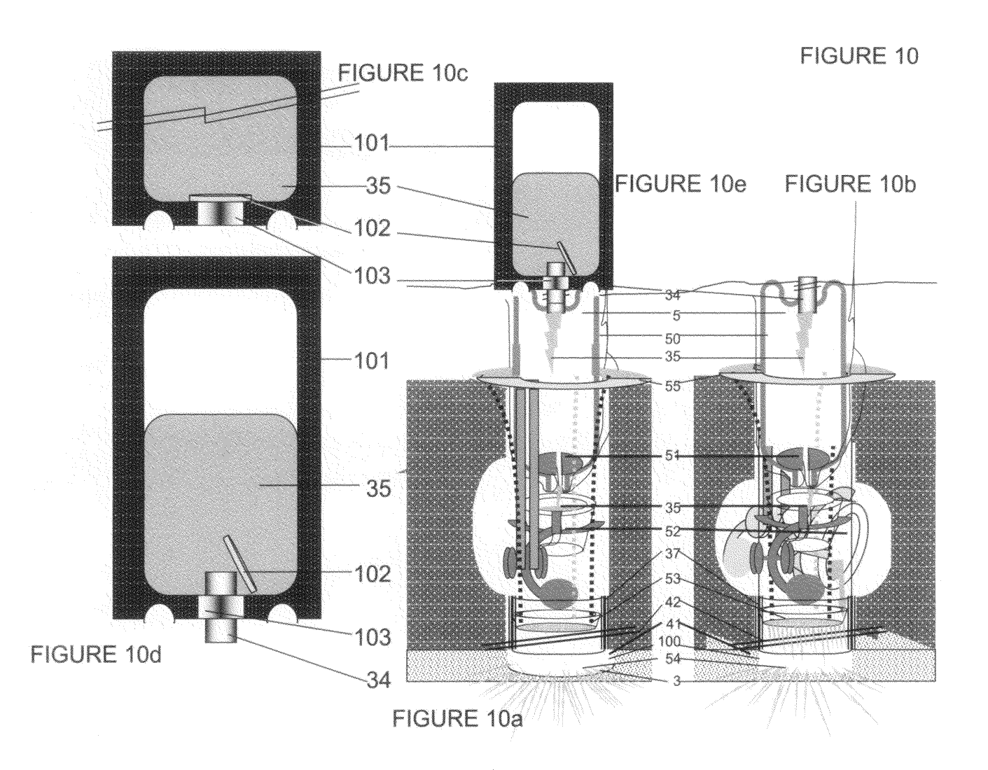

FIGS. 8-9 show the patterns of auxiliary holes 25 around the main drilling 10. FIG. 8a shows the first expansion of the extraction zone, an odd number square matrix with holes at the intersections, the center being the main shaft 10. As the extraction process penetrates the frozen center created as shown in FIG. 1, with heat 45 shown in FIG. 2, the expansion will penetrate the frozen zone 44 holding back ground water unless this frozen zone is expanded. The Liquid Nitrogen treatment as shown in FIG. 10 is applied in the auxiliary holes 25. As the extraction zone extends further, FIG. 8b shows an additional set of auxiliary holes 25 encircle the first set. The Nitrogen units 5 shown in FIG. 10 are moved to the outer encircle of auxiliary holes 25 and the heating units 28 are placed in the inner encircle of holes just vacated by the Nitrogen units. This expansion of auxiliary holes is believed to work for as many as six encirclements of the center shaft 1, or to include 168 auxiliary holes 25. The space between the encirclements is estimated to be 3 meters or 25 feet making a maximum field of 300 feet square, over 2 acres or, in metric, 1,296 square meters.

Because Methane hydrate will evaporate completely being that it is pure, white, and flammable Methane hydrate, the risk of collapse of the extraction zone is higher than for shale, coal or landfill seams, with peat being questionable as to collapsing. FIG. 9 shows means to keep the extraction functioning through a collapse of the center of the extraction zone. Inserted through the main hole prior to the heater and other hardware are collapsible, ribbed piping 100 in preconstructed configurations. FIG. 9a shows the simplest expansion with one unit tubing which would allow evaporants to be pulled from a collapsed array with two encirclements of auxiliary holes. FIG. 9b shows the preconstructed tubes 100 including a secondary segment that will carry evaporants from three encirclements of auxiliary holes, and FIG. 9c shows the top view of their deployment. FIG. 9d shows the preconstructed tubes 100 accommodating four encirclements of auxiliary holes 25, cross section view, and FIG. 9e provides the extended top view. These top views show the shaft 10 and auxiliary drillings 25 in proper pattern designating the auxiliary drillings with heating units 33 and those with Nitrogen provided with the dewars 50 in place. The outer ring with dewars 50 freezes the periphery 44 keeping protection in place against invading ground water. The center holes 33 define the extraction zone 45.

FIG. 10 defines the initial auxiliary drillings, a method of inserting Nitrogen in the periphery of the Methane hydrate seam 1. These drillings are narrower holes, 10 centimeter diameter, maximum, around the periphery of the drill site. A plastic sleeve 100, ribbed like one's windpipe goes from the platform, through the waters and down through sea bottom surface to the top of the Methane hydrate seam. At the top of the seam, a sieve breaks the Liquid Nitrogen into drops so it rains in the seam cavity of the auxiliary hole evaporating into exceedingly cold Nitrogen gas 3. These allow one to add Nitrogen 3 to the mix by putting in the Liquid Nitrogen Enabler coal mine fire fighting equipment 5 including a four liter dewar 50 with an apparatus for slow flow from the dewar 51 which fills a dump bucket 52 with Liquid Nitrogen shown in FIG. 10a which, when full, dumps the Liquid Nitrogen 35 shown in FIG. 10b into the sieve with spaced small holes at the top of the Methane hydrate seam 53 which separates the Liquid Nitrogen drop into tiny droplets that evaporate rapidly as they fall from the sieve. The cold Nitrogen gas 3 flows to the bottom of the drilling and seeps into seam 1 so it carries the evaporated hydrocarbons 15 into the evacuation drilling or shaft 10 shown in FIG. 2. When the dewars 50 are taken for filling, the drilling hole top is sealed with a bowling ball when used on land. When the dewars are in place, they seal the top of the hole as well, preventing the Nitrogen from flowing out of the narrow drill hole and insuring that it seeps into the porous seam structure to carry the evaporated hydrocarbons to the shaft. This operation does two things. First, it reduces the amount of Oxygen available in the hydrocarbons lowering, and hopefully eliminating, the chance of starting a coal mine fire, shale fire or peat fire and here a Methane hydrate fire. Second, it helps carry the evaporated hydrocarbons to the collection and extraction site.

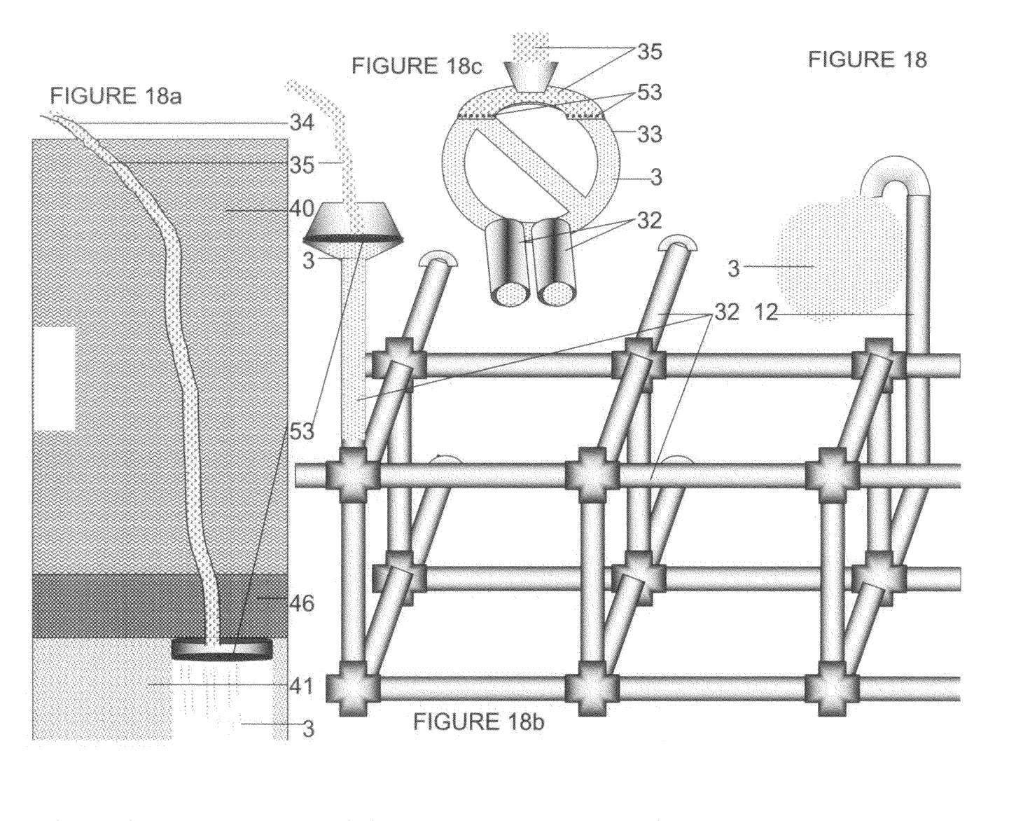

To transport the Nitrogen from the platform, there are two ways: first, using a long ribbed delivery tube as shown in FIG. 18a, and second, using a heavy metal transport dewar 101 as shown in FIG. 10c where Liquid Nitrogen 35 is carried to the depth of the Methane hydrate deposit. The transport dewar has an opening 103 in the bottom of the dewar with an hinged lid 102 holding the Liquid Nitrogen securely in the dewar. When it meets with the dispensing dewar, its filler pipe 34 is inserted in the opening 103 pushing up the hinged lid 102 to allow Liquid Nitrogen 35 to flow into the dispensing dewar as shown in FIG. 10d. FIG. 10e shows the two dewars, 50 and 101, mated at the floor of the ocean or sea passing Liquid Nitrogen 35 into the dispensing dewar 50 from the transport dewar 101. Vents are accommodated in both dewars.

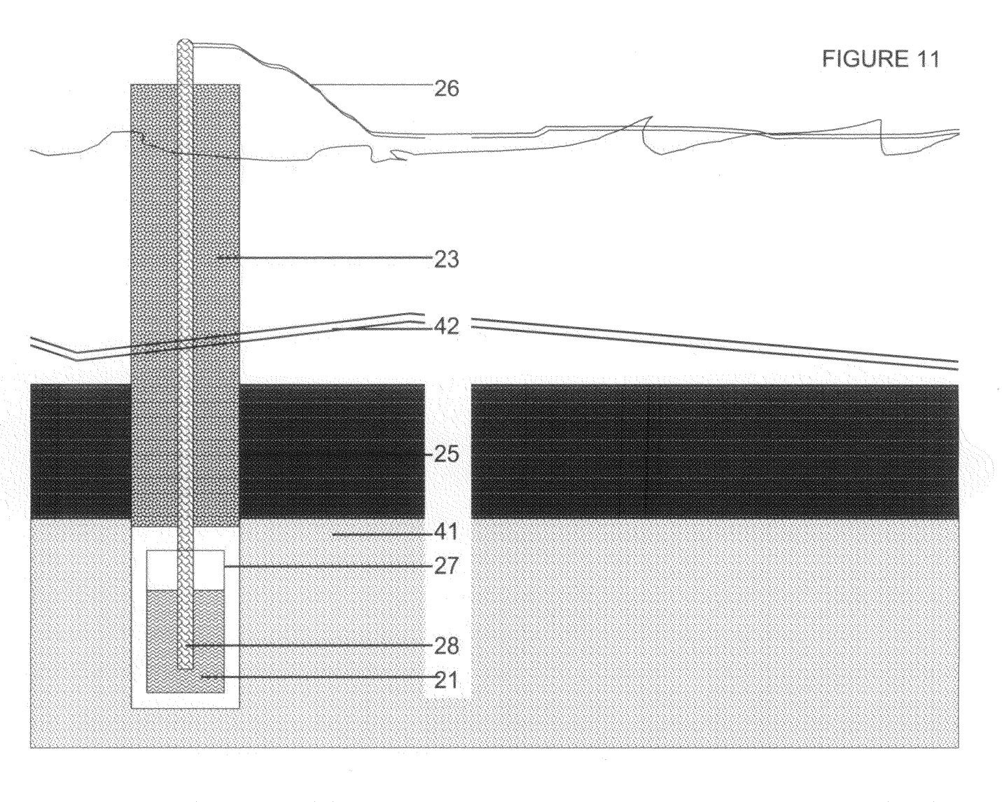

FIG. 11 shows an auxiliary heating of the Methane hydrate seam 1. As the draw of hydrocarbons into the shaft 10 continues, the periphery of the extraction range grows. The holes that held the coal mine fire apparatus 5 can next be equipped with an auxiliary heating unit 2. The heating unit is powered by the energy source and the wiring to the heaters 26 is shown. The hole heating unit 2 consists of the heat energy source 20 which extends the depth of the hole with its heating element 28 in a boiling can 27 that has a fluid in it 21 which boils at the temperature desired to heat the seam 1, as, if one wanted to extract all hydrocarbons from fuel gas to heating oil, one would heat it to heating oil extraction temperature, 375° C., which is higher than the cracking temperature of kerogen in oil shale. The whole apparatus is lowered down the narrow drilled hole 25 and insulation 23 is placed in the hole to insure no heat loss from the extraction zone to the sea bottom surface. This will help heat a larger region of the seam 1 to increase the area or space underground from which the evaporated hydrocarbons emerge. To keep the Nitrogen flow going and the peripheral region frozen, new holes are drilled for the coal mine fire units 5 further from the shaft 10. As that area is exhausted, the heating units can occupy two circles of holes and a third circle of narrow drills is made for cooling with another placement of the coal mine fire units. This can continue with many circles of heating units rimmed by one circle of Nitrogen inserting coal mine fire units 5.

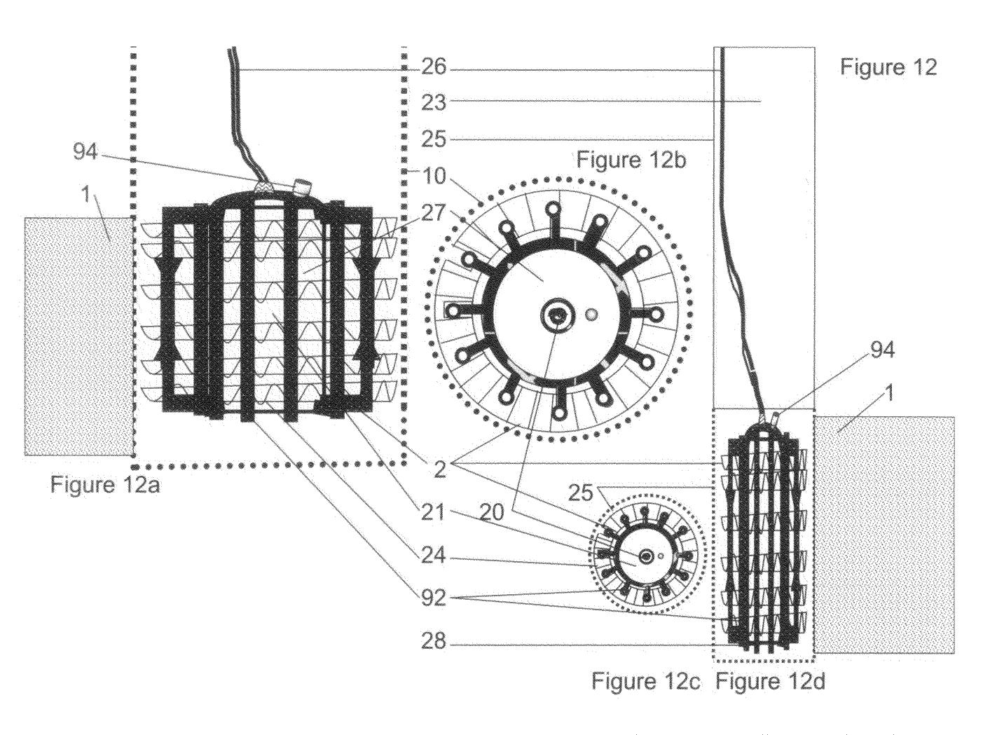

FIG. 12 shows heating units allowing electric heating coils to heat motor oil which boils much higher than the temperature used. The oil 21 rises when heated by the coil to the top of the unit and flows through the “handle” shaped pipes 92 cooling and flowing downward to the heating coil which sends the now hot oil to the top—around and around again. FIG. 12a shows the side view of the large heating units for the shaft. They stack. There are electric wires 26, a filling pipe with cap 94, external tubes 92 heating the radiator tabs 24 which heats the Nitrogen to carry the heat to the fuel seam 1. An electric spiral heating unit 28 is placed in the lower part of the boiling can 27. Heating units 2 allow stacking to match the depth of the shale or Methane hydrate seam for most rapid heating. The power source 22 allows power through wiring 26 which enters each heating element 2. FIG. 12C shows the same type unit in narrow configuration to fit in the auxiliary holes. FIGS. 12b and 12d show the top views of these heating units 2.

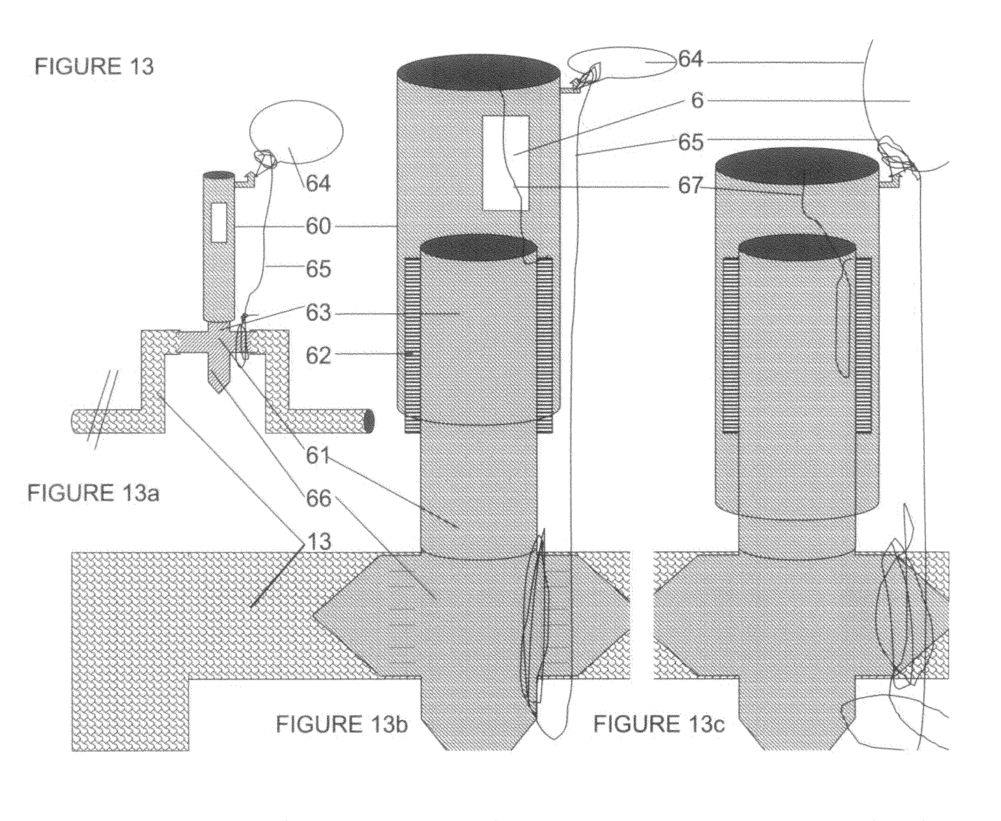

FIG. 13 shows in FIG. 13a a means to preserve for marketing the rare gases that emerge from the Methane hydrate seams as the last component of the condenser 13. The rare gas extractor 61 is comprised of an inserted elbow pipe insertion 66 placed in the condenser piping 13 which has a vertical pipe 63 to release the rare gases 6 into the inverted rare gas container 60. As the rare gas 6 fills the inverted container 60, it becomes lighter weight and rises on the vertical pipe 63 as shown in FIG. 13b. Brushes 62 on the outer wall of the vertical pipe 63 keep the inverted container 60 properly vertical. To save these light gases, the rare gas extractor 61 opens and allows the rare gas 6 to flood the mylar balloon 64, which lowers the inverted container 60 on the rare gas release tube 63 as shown in FIG. 13c. The trigger to open the valve on the rare gas extractor 61 is the tether line 67 attaching to the inside top of the rare gas container 60 and the inner wall of the vertical pipe 63. When the tether line 67 is tight because the rare gases have lifted the container 60 so high the line is tight, the valve opens on the extractor 61 and the rare gases enter the mylar balloon 64. As it does the container lowers, loosening the tether line, the valve has a time delay to allow the rare gases to enter the balloon. When the top of the container 60 strikes the vertical tube 63, the valve shuts allowing rare gases to accumulate again in the rare gas container 60. When the balloon is filled it is held to the ground with the tether line 65. Once the mylar balloon 64 is filled, it will be removed from the rare gas extractor, and its opening folded and sealed as is common practice in use of these balloons. The balloon 64 is kept on the tether line 65 as it is stored and carried to market. Rare gases 6 contained are hydrogen, helium and neon. Argon, another noble gas, along with Oxygen are captured as the final condenser gas drum since its condensing temperature is higher than that of the Liquid Nitrogen and Nitrogen gas just after evaporation will liquefy Argon and Oxygen at just over 160° C. so they run through the trap and evaporate in the gas drum as shown in FIG. 5.

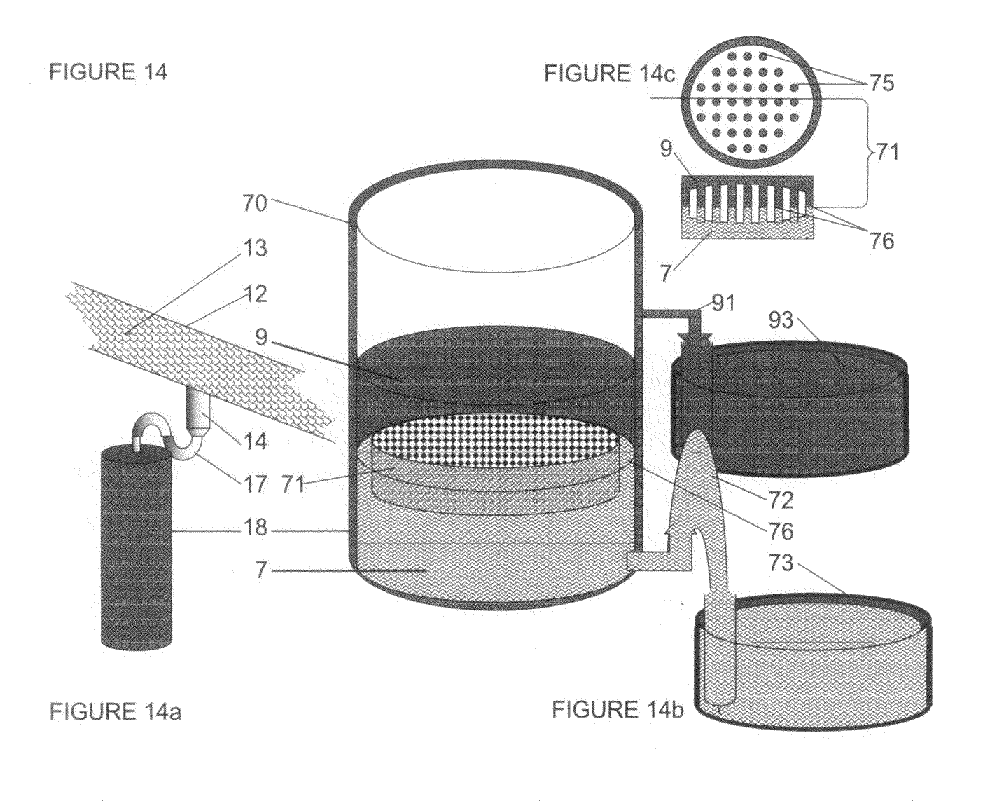

FIG. 14 shows the manner the condenser separates water, boiling and condensing at 100° C., from the gasoline fraction of the hydrocarbons, condensing at between 40° C. and 200° C. This segment is split into two components, heavy gasoline between 200° C. and 120° C. and light gasoline between 120° C. and 40° C. which includes the water condensation. The container 18 collecting the light gasoline segment is shown with the segment output 14 attached to the gaseous escape pipe 12 in the condenser 13 with its trap 17 and container 18 is illustrated in FIG. 14a. Details of this particular container 18 are shown in FIG. 14b. These include a float lighter than water 71 and heavier than light gasoline which has spaced holes and rides between the liquid of the light gasoline 9 and the water 7 keeping the interface calm and undisturbed as the added condensed materials enter the vessel. This water/gasoline separator 70 has the float 71 defined by rounded shape with a pattern of holes 75 shown in FIG. 14c in the vessel 18 and a siphon tube 72 draining the water 7 from the vessel into a water container 73. When the volume of the cylinder is close to full, the light gasoline extractor 91 allows the gasoline fraction 9 to empty into the light gasoline container 93. Not shown here are: the trigger floats noting the height of the gasoline 9 and the float 71 which properly high and spaced opens the light gasoline extractor 91 to drain some of the gasoline, and the float height that triggers the water siphon tube 72 to drain emptying some water into the water container 73; and the final water purifying process of slowly freezing the water in cubes and lower its temperature well below freezing such that the contaminants are eliminated from the water crystal of the ice. Surface contaminants can be removed by wiping or lifting the ice cube from its container where the rejected contaminates remain or a quick pure water rinse. This purifying process is common. In the oceans, when ice bergs form, the salt and organics in the water are eliminated from the ice crystals and left in the ocean water. Tasting ice from an ice berg and sea water just beside the ice berg will allow one to experience the difference of contamination, the ice berg being more like fresh water and the sea water, salty. FIG. 14c defines the float 71 between the light gasoline 9 and water 7 segments which has spaced holes 75 holding the liquid relatively calm so the gasoline/water separation 76 easily reforms after condensation pours into the container 18. Since Methane hydrate isn't expected to contain gasoline weight carbons, the water will condense here with little, if any, organics. The system must be complete when used.

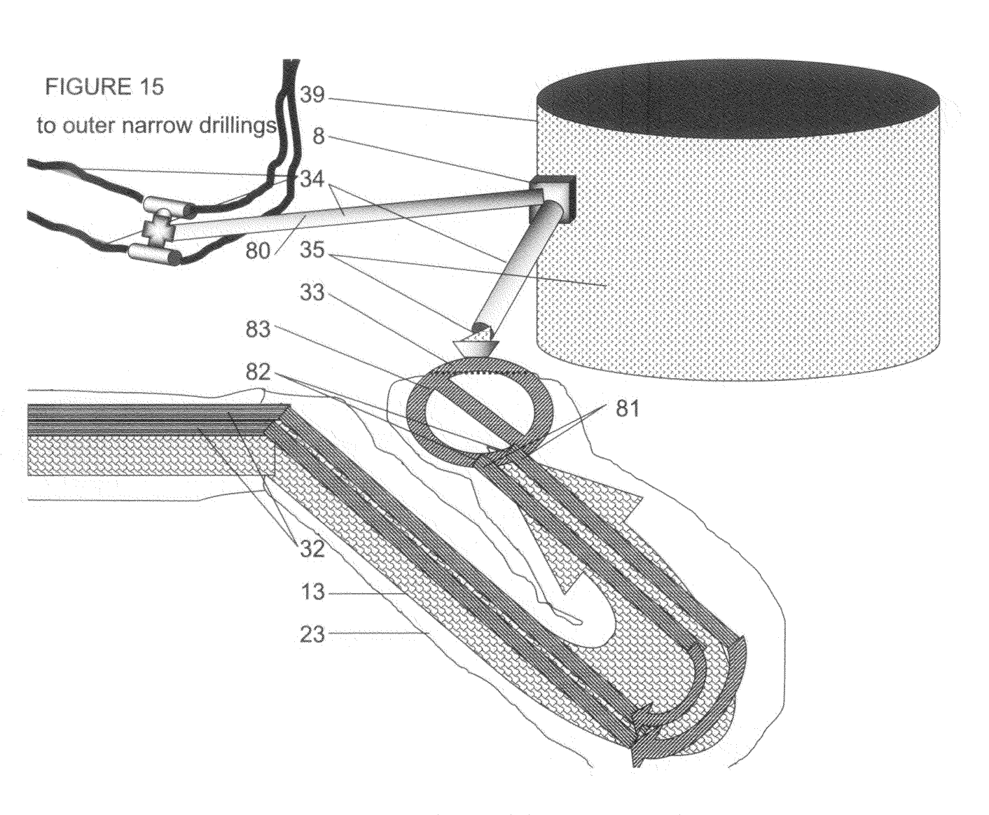

FIG. 15 shows the physical features of the regulated Liquid Nitrogen 3 flow with the regulator 8 on the tank of Liquid Nitrogen 39 feeding two Liquid Nitrogen pipes 34, one feeding the condenser 13 including the evaporation chamber 33 and the other feeding the secondary Nitrogen input 80. With condenser 83 feeding Nitrogen gas into the one-way valves 82 allowing Nitrogen gas 3 to enter the Nitrogen insertion elbows 81 inserting the Nitrogen into the Nitrogen pipes 32. This Nitrogen gas, of course, drives the organ pipes and, after a romp in the extraction zone, carries the evaporated hydrocarbons out of the shaft. This system keeps thermal levels of the segments of the condenser constant because the thermostats imbedded in the condenser 13 drive the regulator to determine if any or how much Nitrogen gas should be fed into the Nitrogen pipes to keep shaft functions at needed levels. The condenser segment temperatures remain at determined levels to get appropriate fractions of the hydrocarbons extracted from the Methane hydrate seam along the shaft and in the extraction zone. The rings of auxiliary heaters and the outer ring force Nitrogen gas into the shale or Methane hydrate seam as well.

FIG. 16 is included to show where each of the extracted components from the shale and Methane hydrate seams are collected including: Rare Gases as Hydrogen, Helium, and Neon; Argon; Methane; Ethane; Fuel Gas; Light Gasoline and Water (separated in second stage); Heavy Gasoline, Jet Fuel; Diesel Fuel; and two sections of Heating Oil. This array of components isolated will probably be a maximum sized group of isolated elements, molecules and molecule mixtures. Methane hydrate extraction may abbreviate this list of condenser outlets.

This clean method of hydrocarbon extraction should allow the readily burnable parts of Methane hydrate can be extracted from underground with minimal disturbance of the site and with little chance of sinking surface structure after the extraction. It may replace surface mining as we know it, eliminate underground coal mining as we know it, and bring hydrocarbons from some situations where mining would not be practical or economical, as here with Methane hydrate being 300M to 500M below the sea and shale, because of the difficulty of extraction of the material kerogen and its derivatives.

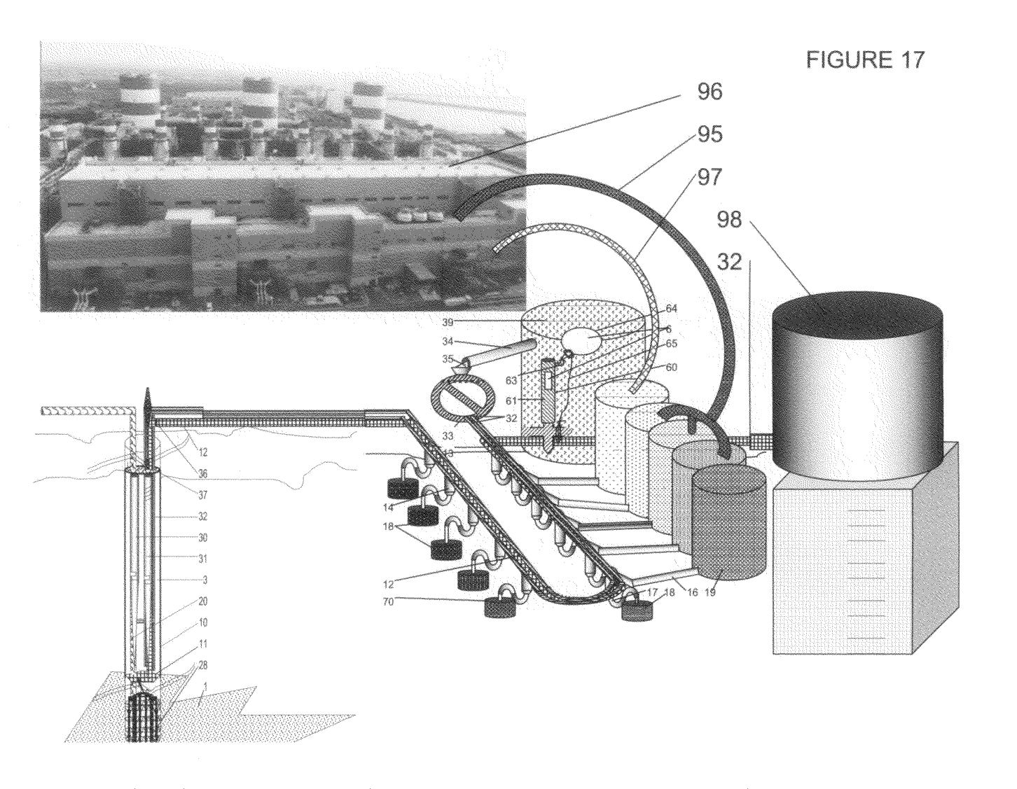

FIG. 17 expands the system for Methane hydrate extraction adding on the platform, possibly a retired battle ship, a natural gas electrical generating plant 96 (as the Taiwan plant pictured) fueled by the light fuel gases, Methane, Propane, Butane 95 and using the collected Oxygen/Argon 97 to oxidize the burn insuring full oxidation of the carbon and any nitrogen, sulfur or phosphorus radicals. This allows removal of Nitrates, Sulfates and Phosphates from the stack gas with the scrubber system described in the DuBrucq patent application Ser. No. 11/825,992 to prevent acid rain, and, to feed the crew, a green house to absorb much of the Carbon dioxide from being released into the air by the exhaust from the natural gas power plant on the platform. This allows some bottled compressed gas to be shipped to shore with empties brought with each pickup and an electric power cable to carry generated electric power to shore coupled with the fresh, distilled water pipeline. And because of the expected remote location, the Nitrogen gas exhausted from the system 32 is liquefied 98 on the Platform using some of the generated electric power. Though not shown, a cryogenic feeder pipe will carry the newly liquefied Nitrogen to the dispensing tank to carry forward the condensing process.

FIG. 18 shows converting Liquid Nitrogen 35 to Nitrogen gas 3. First, FIG. 18a shows flowing Liquid Nitrogen 35 down a ribbed pipe 100 to the ocean or sea floor, as referred to in the FIG. 10 text, where the evaporation happens as the Liquid Nitrogen encounters the sieve 53 causing it to rain Liquid Nitrogen and quickly evaporate to Nitrogen 3 at the cryogenic temperature of 195.8° C. This induces freezing of the embedded water preventing unwanted sea water from penetrating the extraction zone. FIG. 18b shows an immediate evaporation with the sieve 53 at the point of entry of the Liquid Nitrogen 35, here illustrated as being administered to a pipe matrix as would freeze an ice barrier to prevent water flowing through a break or breach in a dam or dike as described in DuBrucq patent application Ser. No. 11/706,723. FIG. 18c shows the Liquid Nitrogen 35 injection into the condensing system 33 with the sieve 53 causing the rain of Liquid Nitrogen evaporating it into Nitrogen 3 which flows into the two Nitrogen source pipes 32 to begin cooling the evaporated fuel and water with the returning Nitrogen mix.

FIG. 19 provides the initial Nitrogen saturation of the Methane hydrate or coal, shale, peat or landfill seam 41 where the exhaust Nitrogen gas 3 from condenser pipe 32 into the air compressor 19 storing Nitrogen 3. When the drilling occurs, the Nitrogen 3 regulated by the air pressure gage 99 flows as compressed Nitrogen gas 48 to connector 37 on the drill 25 operated by the pneumatic hammer drill rig 49 operated on the drill tractor 89, either manually controlled on the ground 46 or robotically controlled on the sea bottom 46. The compressed Nitrogen gas 3 both pushes the drill bit 25 upward allowing another hammer stroke downward into the seam 41. In the process, this push also causes the Nitrogen 3 to penetrate the seam 41 more and more with each stroke.

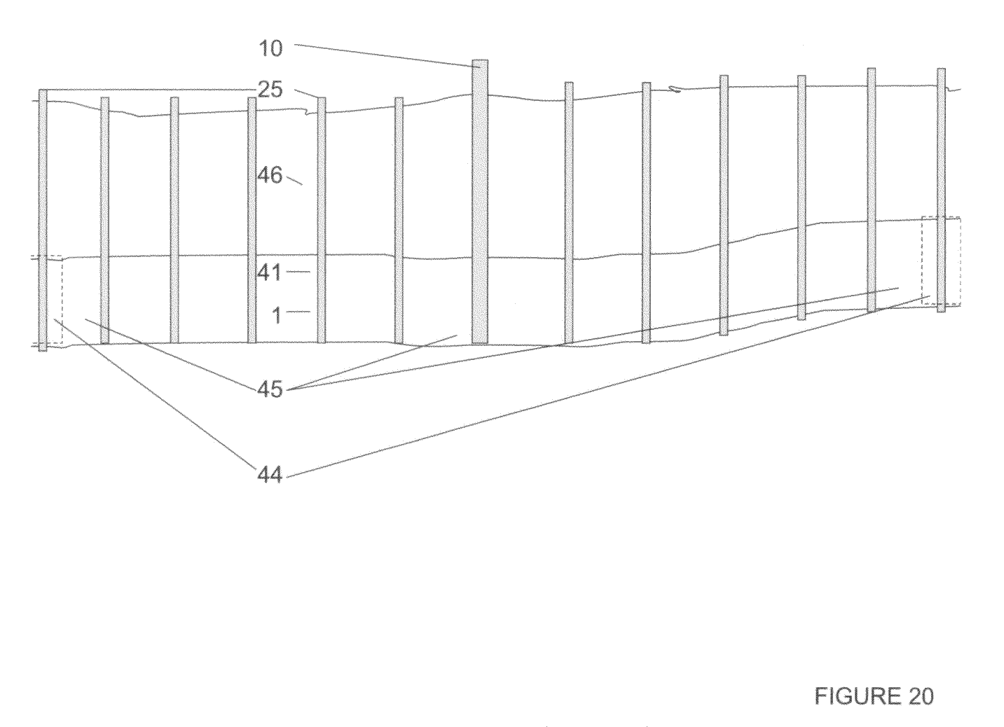

FIGS. 20-22 define the extraction zone expansion as occurs with continued extraction. In FIGS. 89 we saw the initiation of extraction to up to four rings of auxiliary drilling, to an 81 hole matrix with one shaft and 80 auxiliary holes, having the outer ring of holes cryoed with Liquid Nitrogen dispensed in 32 holes and heaters in the remaining 48.

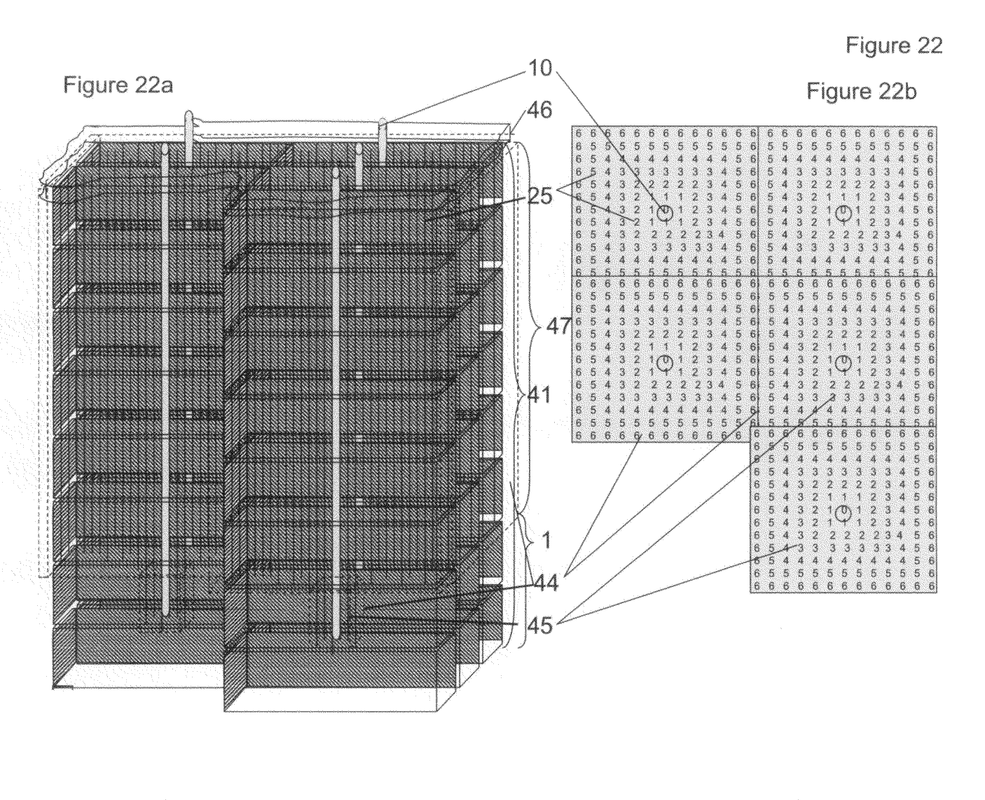

FIG. 20 shows the fully expanded extraction zone 41 under the sediment layer 46 over the Methane hydrate deposit. Shown are the main shaft 10 and the auxiliary tubes 25 which would fill the matrix of six expansions from point 1 going in odd numbers as 3², 5², 7², 9², 11², and 13², giving the example total of 169 drillings, one 18″ or half meter and the 168 auxiliary holes at 6″ or just over a centimeter diameter. The cold zone 44 provides the peripheral ring keeping out ground water, and the center 121 drillings define the hot zone 45 where the heaters raise the temperature to 375° C. or as needed evaporate the organics 1 and contained water. This is a cut-away view. FIG. 22 shows top view.

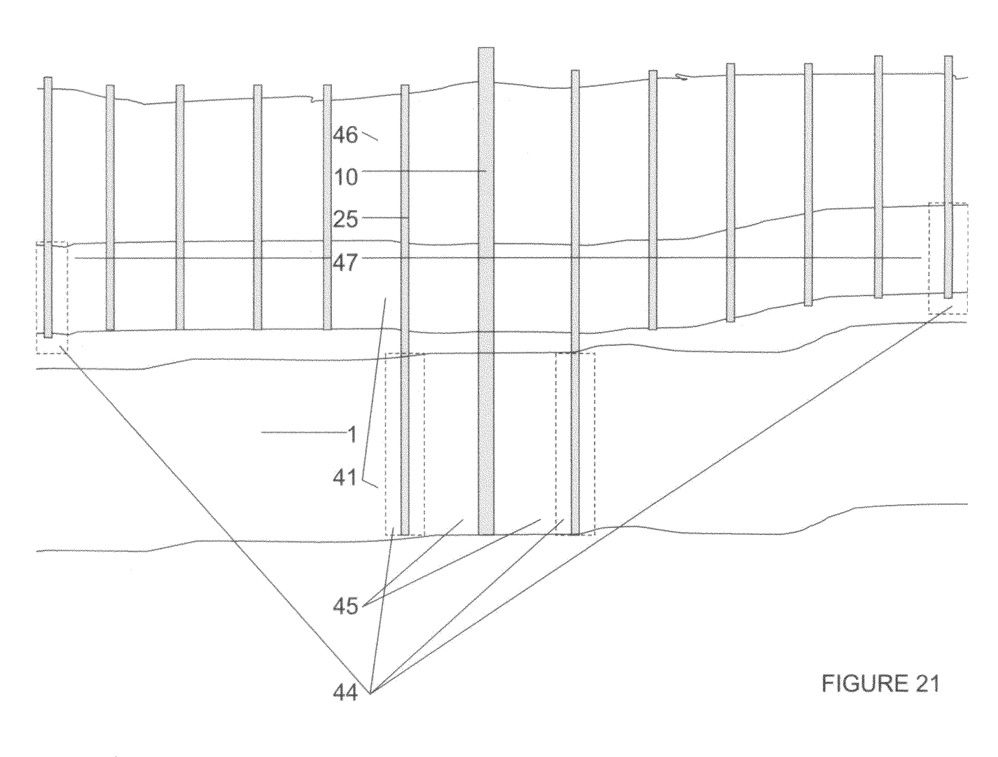

FIG. 21 illustrates the further expansion of fuel extraction where the extraction zone 41 is an exhausted seam 47 and the shaft 10 has extended to another layer in the Methane hydrate or shale seam. The sequence is FIG. 2 and FIG. 1 occurs in the new extraction zone 41 and as the extraction progresses, the first ring of auxiliary drillings 25 has been extended into the new extraction zone 41. The cold zone 44 is shown as being in both the new first ring of auxiliary drillings 25 and persisting in the outer ring of the exhausted zone 47. This is done to preserve the periphery of the stack of extraction zones from invasion of ground water or sea water from beyond the stack of extraction zones. The hot zone 45 is only around the shaft 10 in this layer.

FIG. 22 shows a very mature extraction area with simultaneous operations in five neighboring matrices, and, shown in FIG. 22a, having, so far, exhausted six layers of an intended 8 layer extraction area. Yes, one can combine the condensation operation with running heated and thermostatically controlled Nitrogen pipes 32 carrying evaporated hydrocarbons, water, and Nitrogen gas carrying the stack output from each to a central condensation operation. That would mean than some ten acres of extraction would only need on central extraction area where the drums and barrels and huge thermos of Liquid Nitrogen 39 would be located. The Nitrogen pipes would divide into the double pipes going to each stack 10 and electric wires would have to go to the 120 auxiliary heater ducts 25 in each extraction zone, and workers would refill several times daily the Liquid Nitrogen dewars in the peripheral ring of auxiliary holes and the outer holes of the expansion of exhausted extraction zones 47, carrying number “6” in the top view FIG. 22b showing ring numbers 1-6 in the patterns of auxiliary holes. The fuel 1 is still contained in the lower two layers yet to be extracted. The only hot zone 45 is the central section of the seventh layer and the cold zone 44 surrounds it and is the periphery of the exhausted layers in the top to sixth now exhausted extraction zones 47.

This combining areas of extraction and doing limited height layering of the extraction zone will keep the character of the land intact with the extraction of the fuel below. In shale work, the landscape disturbance would be minimal and after extraction, the remaining shale would hold its dimensions and the electric wires and insulated pipes would be removed leaving the forest nearly as primeval as it was before extraction. If this type operation would cause the start of a wilding fire, with Liquid Nitrogen on hand and troughs as described in DuBrucq patent applications Ser. Nos. 11/706,723 and 11/750,149 would immediately end the fire before it could leave its original location or threaten the extracted fuels further. Any place there is heated fuel, it is carried in Nitrogen gas, a recognized fire. suppressant included in National Fire Protection Association (NFPA) Code 2000 covering gaseous fire suppressants. And were any wildland fires started by lightning or man nearby, the availability of Liquid Nitrogen and the fire protection that would be at these sites as described, would allow immediate control of the fire before it could spread. This should be general practice in wildland fire control, but for whatever reason, the authorities are not applying it. This decision is costing taxpayers dearly in wildland fire fighting at this writing (Jul. 7, 2008).

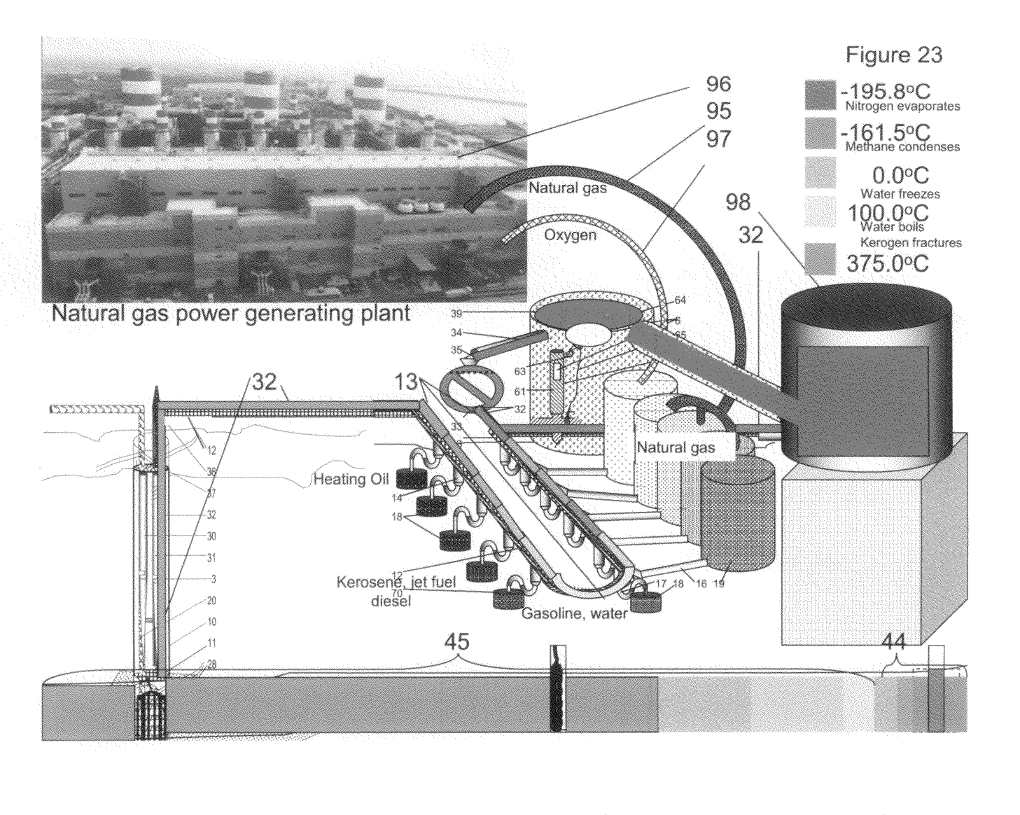

FIG. 23 provides thermo definition of the extraction process. The drawing chosen is that of FIG. 17 where all the parts are defined by number. Viewing the extraction zone, the hot zone 45 extends past the first auxiliary drilling with the heater and the cold zone 44 is around the last auxiliary drilling where the Liquid Nitrogen is applied to freeze the periphery.

Viewing the color code, the Liquid Nitrogen temperature, −195.8° C., is as cold as anything in the system gets and it is in the Liquid Nitrogen generating plant 98, the storage tank 39 and the delivery pipes 34, and as provided, in the peripheral auxiliary drillings where the just evaporated Nitrogen gas 3 retains that temperature to cool down what the cold molecules hit.

The next significant temperature is the condensing temperature for Methane, −161.5° C., where you can see the aqua color at the condensation point in the condensing system 13 and near the peripheral auxiliary hole as the Methane hydrate seam is cooled.

Next come the freezing, melting point of pure water, 0° C., and the boiling, condensing point of water, 100° C. This is significant in two places—first—in the condensing tube 32 where the water condenses and is pulled from the carrier gas, Nitrogen, and—second—around the peripheral auxiliary area where the freezing point of water, 0° C., is needed to fully surround and protect the entire extraction zone from ground water or sea water invasion. If that occurred, the extraction process would be glutted with water and the whole process would be a waste of time. Extraction would be stopped and the equipment in the ground be recovered for use at another location.

Finally, the last significant temperature is that selected as the highest used in the extraction process. It is what each heater unit is set to operate at. The selection we have here is 375° C. so it will evaporate fuel fractions through heating oil. Note the sustained temperature through the extraction zone, up the extraction pipe 32 and into the condensing system 13. The thermal choice may differ from coal, shale, peat and landfill seam extraction for Methane hydrate deposit extraction, but were the other fuels present in this deposit, they could be extracted and recovered without hindering the process. The Methane must have come from residual organic decomposition, so it is not improbable that there are other fuels but Methane in them.

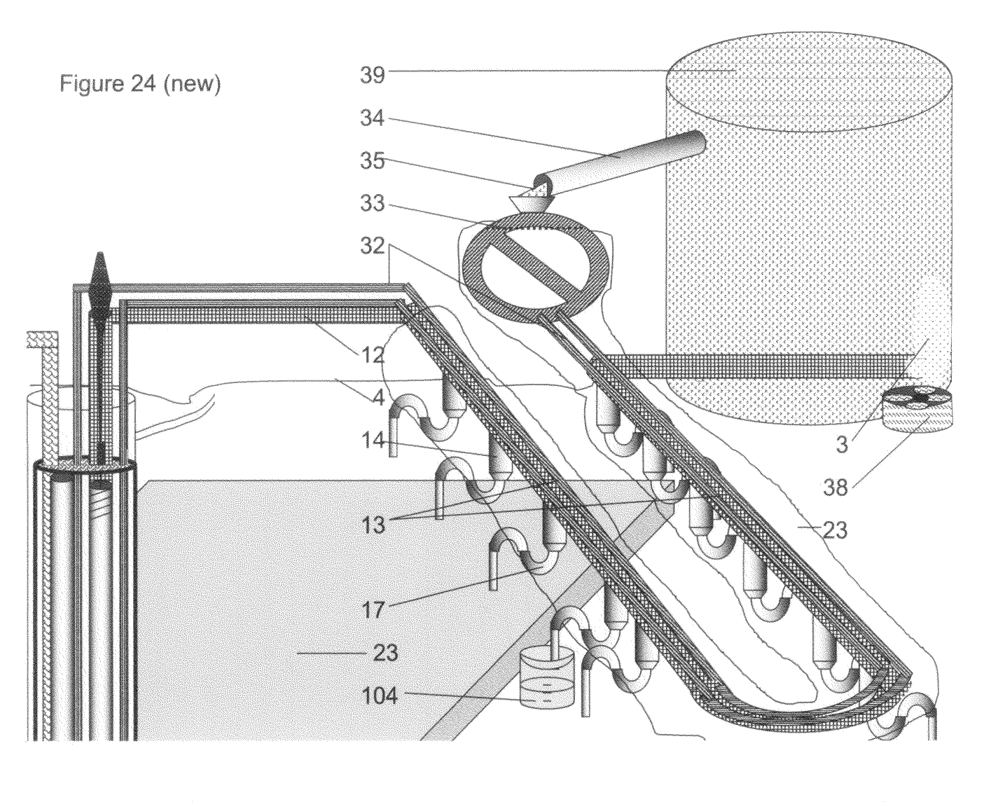

FIG. 24 provides the description of changes needed when applying this method to pulling organic pollutants from the ground including a pollutant specific extraction apparatus 104 with calibrated receiving vessel and a thermal insulating cover 23 over the ground under which the pollution is heated to evaporating temperature and carried to the surface in a Nitrogen atmosphere. The range of condensation for the specific pollutant is its boiling point ±X° C. surrounding the boiling point of that pollutant as for the TCE, Trichloroethene, one might choose 87±2° C. for capturing that pollutant. The next closest pollutant is 1,2-Dichloroethene (total) (1,2-DCE) where collecting it at 83.5±2° C. would require narrowing the thermal range to not contaminate the samples thus, if both pollutants were present in the extraction zone, the limits would best be 87±1° C. for Trichloroethene and 83.5±1° C. for 1,2-Dichlorothene (total) (1,2-DCE). This task requires tighter calibrating of the thermal zones than would be needed for fuel extraction.

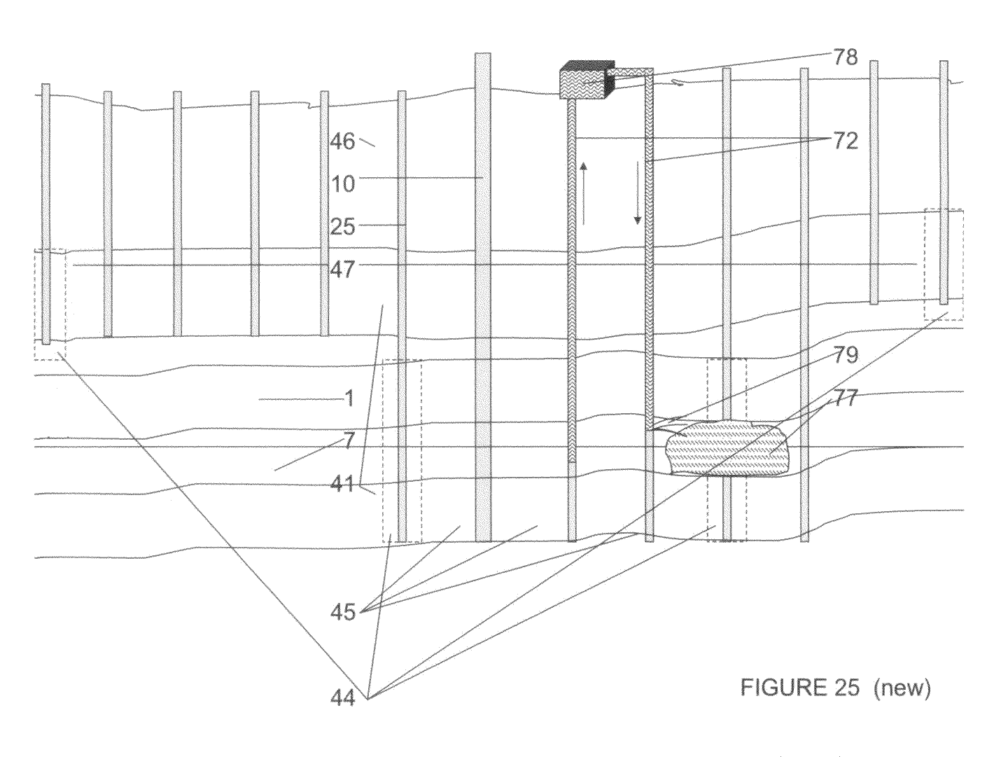

FIG. 25 provides a means to prevent loss of integrity of the extraction zones by using, as shown here, water 7 from warm sections of the zone 45 and/or one could use the extracted water from the condensing system, pulling it to the surface with a sump pump 78 via a water tube or hose 72, and returning it to the layer via another warm zone location closer to the frigid zone 44, towards which the water spray 79 causes a buildup of ice 77 which seals the aquifer or other layer from top to bottom preventing loss of Nitrogen carried fuels or pollutants. This technique makes aquifer or other layers in the rockbed which contain empty space which leaks air from the extraction zones because of the liquid content of those layers solid so the fuel laden Nitrogen does not escape.

The final page of the drawing sequence is the number code for FIGS. 1-25 to assist readers and the examiner in comprehending all that is represented in this complete system of fuel extraction from natural and man-made sources of organic materials. Even the inventor has gotten the numbering system a bit bungled in the writing process and was aided in getting it right by this item. “You can't tell the players without a program”—the cry at the ballpark is paralleled here with the “you can't tell the parts without this list.” The inventor hopes it helps.

This completes the statement of invention.

Therefore I claim:

1. A method of extracting evaporated hydrocarbons from a Methane hydrate or shale seam
using a primary shaft drilling comprising the steps of:
a. cooling the Methane hydrate or shale seam to brittle with Liquid Nitrogen to enable vibration shock to open the seam formation for hydrocarbon extraction,
b. heating the Methane hydrate or shale seam with a contained heat source at the seam level in the lower parts of the main shaft;
c. vibrating the Methane hydrate or shale seam with single frequency sound and another nearly matching it, but not quite, to provide harmonic beating to jar the seam structure allowing escape of fuel and evaporated water;
d. applying Nitrogen gas to the shaft environment initially using it to activate the sound source, then to be a fire suppressant and an inert carrier of the evaporated hydrocarbons emerging from the seam into the shaft, and, at the same time; and
e. keeping the Nitrogen gas pressure such that the shaft functions are kept at required levels of vibrations and carrying the evaporated hydrocarbons out of the shaft and into processing.

2. The method according to claim 1, wherein the heating unit raises the Methane hydrate or shale extraction zone temperature to the highest temperature of the longest carbon content hydrocarbons or the boiling point of water extracted determining the range of hydrocarbon fractions being extracted from the seam.

3. The method according to claim 1, wherein the cue or harmonic vibration rate, beat, causing the highest extraction rate for the evaporated hydrocarbons from the Methane hydrate or shale seams into the shaft for extraction.

4. The method according to claim 3, wherein the adjustable organ pipe can be robotically adjusted or driven to scan harmonics remotely and enter matched tuning with the fixed tone organ pipe repeating the process at the best period for fuel capture rates.

5. The method according to claim 1, further comprising the carriage of the evaporated hydrocarbons with Nitrogen gas heated to the highest temperature of the heaviest hydrocarbon desired to be extracted, or, if only light gases are present, the boiling point of sea water—somewhat over 100° C., allowing for ionic content.

6. The method according to claim 5, further comprising the collection of the hot Nitrogen/Hydrocarbon into an isolated extraction tube taking these gases hot from the shaft.

7. The method according to claim 1 of regulating Nitrogen flow such that the thermal segments of the condensing system are kept at constant conditions so the separated hydrocarbons are accurately fractionated keeping the output in reliable fractions of hydrocarbons.

8. A method of extracting evaporated hydrocarbons from Methane hydrate deposits using a primary shaft drilling, and as the extraction continues, auxiliary narrow drillings to enable continued evaporated hydrocarbon extraction comprising the steps of:
a. drilling narrow auxiliary holes and applying a pulsed application of Liquid Nitrogen through a spaced hole sieve making Nitrogen droplets that evaporate rapidly as they drop down the hole releasing Nitrogen gas into the extraction zone freezing to brittle the periphery of the extraction zone allowing vibration to fracture the material and maintaining an ice seal around the extraction zone.
b. as it heats up, the hydrocarbons evaporated are carried to the main drilling in the gaseous Nitrogen flow and as the ring of these units freezes it keeps the ground water from entering the active extraction zone.
c. forcing the Nitrogen gas to seep into the seam by feeding the pneumatic hammer drill or other air requiring digger to use compressed Nitrogen gas rather than compressed air, which will keep the Oxygen level low in the extraction zone further preventing explosions and fire.
d. sealing the drillings with sleeves to retain opening and prevent water and gases from contaminating the extraction zones using a gas impervious sleeve.
e. increasing the sequence of rings of holes, keeping the furthest hole ring for the application of the Liquid Nitrogen provides the carrier gas to the extraction zone extreme distances so the hydrocarbons evaporated are carried to the main drilling in the gaseous Nitrogen flow and as the ring of these units freezes making an ice wall periphery keeping ground water from entering the active extraction zone, and applying a heating unit to the holes where earlier the Liquid Nitrogen was applied.
f. regulating the temperature of the narrow drilling heaters to the desired temperature, as that of the highest temperature of the highest carbon count molecules of the fraction of hydrocarbons desired to be extracted.

9. The method according to claim 8, wherein the Nitrogen sourcing insures the Nitrogen gas evaporating from the Liquid Nitrogen seeps into the shale. or Methane hydrate deposit by keeping the top of the drilling sealed and lining the drilling to the seam levels with Nitrogen gas-impenetrable material.

10. The method according to claim 8, further comprising the heating of the inner narrow drillings by insulating the narrow drilling down to the Methane hydrate extraction zone upper level so all the heat produced affects the temperature of the extraction zone and restricts external heating as much as possible.

11. The method according to claim 8, wherein the heating unit in the narrow drillings is controlled by an enclosed liquid boiler at the temperature desired with a thermostat and by selection of the boiler liquid to not boil at that temperature and not to decompose as the heating element is immersed to heat the liquid to the temperature selected to heat the seam.

12. The method according to claim 8, which prevents ignition of the seam by containing the heating element in a boiler and flooding the porous seam with Nitrogen, a fire suppressant, NFPA Code 2000, which is the carrier for the evaporated hydrocarbons.

13. The method according to claim 8 which uses a large heater, electric using a heating element in the lower section of the boiling can or fuel gas heating of the liquid using extracted fuel gas with cooler liquid drained to the flame heater at ground level with one-way valves keeping the fluid rising and the heated liquid proceeding upward with one one-way valve keeping the heated fluid going down to enter the boiling can through a funnel in the middle of the can releasing the hot liquid upward with all fluids passing through insulated hoses, with higher boiling point liquid transferring the coil heat to the outside and radiating the heat to the gases in the shaft and drillings and though the coal, shale, peat, or landfill seams evaporating the hydrocarbons designated for extraction.

14. A method of separating the hydrocarbon fractions in a condensing system comprised by the steps of:
a. initiating the infusion of Nitrogen gas by evaporating Liquid Nitrogen in a condenser which feeds directly into two or more pipes delivering Nitrogen gas, one air activated sound source per Nitrogen pipe;
b. running the Nitrogen pipes over the evaporated hydrocarbon/Nitrogen extraction pipe in an insulated packet including the Nitrogen pipes and the extraction pipe with radiator plates to transfer the thermal temperature between the cold pipes of Nitrogen gas and hot gas of the extraction pipe;
c. segmenting the extraction pipe by placing draining pipes with traps in sections of the extraction pipe to drain out condensed liquids and allow their flow into a collecting vessel;
d. accommodating both hydrocarbon fractions which are liquids at normal temperatures and hydrocarbon fractions which are gaseous at normal temperatures;
e. enabling collection of the rare gases, Hydrogen, Helium and Neon, by allowing their rising into a tube and capturing them in an inverted container which allows by their containment in mylar balloons for storage and movement to market and final separation, one from another;
f. separating the light gasoline from water in the collection cylinder with a float with holes to keep the separation from turmoil in the solution when adding condensed liquid mix;
g. further removing contaminants from the water by slow freezing so the crystal structure of the freezing water eliminates other materials;
h. feeding the exhaust Nitrogen gas into a Nitrogen liquefier for use in this extraction process;
i. feeding the exhaust Nitrogen gas into a gas compressor to be used in the pneumatic drilling process so the extraction zone is Nitrogen saturated even before extraction begins; and
j. feeding the natural gases to fuel power generators to produce electricity;
k. feeding the collected Oxygen and Argon to this plant to fully oxygenate the burned fuels; and
l. apply the gas scrubber system to remove contaminants and use the condensed water to water the plants and the emerging Carbon dioxide to provide the carbon compounds for photosynthesis.

15. The method according to claim 14, wherein the cold Nitrogen tubes emerging from the condenser for evaporating Liquid Nitrogen intersect with the extraction tube at its coolest point and flows warming to its hottest point as it is insulated coming from the shaft causing the extraction pipe to have a thermal gradient.

16. The method according to claim 14, wherein the thermal ranges of the extraction pipe are isolated with a drain collecting the condensed hydrocarbons in the segment collecting the highest temperature evaporating (condensing) hydrocarbons in barrels or vessels storing them as liquid at normal temperatures and collecting the lower temperature evaporating (condensing) hydrocarbons that are gaseous at normal temperatures in gas collection drums.

17. The method according to claim 16, wherein the condensed liquids are divided at the thermal point between the neighboring segments at the defined thermal point as defines the types of hydrocarbons, molecules, and atoms using an adjustable barrier so the cooler condensation goes to the colder drain and the hotter segment condenses and flows to the hotter drain of the two materials.

18. The method according to claim 14, wherein the gases that condense at higher temperatures than Nitrogen and are of smaller molecular weights are allowed to escape from the extraction tube by rising in a vertical tube topped with an inverted container that allows transfer to transport-capable containment.

19. The method, according to claim 14 of extracting water from the material condensed by using a secondary separation in the thermal range of water condensation where water being denser than hydrocarbons, will sink to the bottom and the hydrocarbons condensed in that section float on the water and increasing the separation stability with a float riding on water but sinking in hydrocarbons that is slightly smaller than the cylinder and has many holes allowing small regional separation and less splash and mixing as condensed material is added to the cylinder.

20. The method according to claim 19 whereby the water is further purified by slow freezing so crystal structure of water formed forces out contaminates making water that is welcome to a clean environment from the extraction process.

21. A method of clearing the extraction tube of its remaining gas after cooling to minus 162° C., which condenses methane gas, allows condensation of a mix of Oxygen at −183° C. and Argon at −185.7° C., allowing release of the rare gases and then use the remaining Nitrogen to produce condensed Nitrogen gas for use in drilling the shaft and auxiliary holes and for use to liquefy Nitrogen at the extraction site to supply the extraction process and any wildland fire control needs in the area.

22. A method of fuel extraction that has no moving parts, but is driven by thermal changes one set of pipes acting on another whereby the draw is elimination by condensation of the fuel components of the extracted materials.

23. A method of fuel extraction which will not:
a. impact the environment in emissions or major degradation of the landscape or seascape,
b. emit any gases, even the Nitrogen in full configuration,
c. use external water resources or contaminate the ocean,
but will supply:
a. separated fuel fractions from fuel resources as shale and Methane hydrate,
b. fresh, distilled water,
c. semi-isolated rare gases
d. on-site fueled electric power, and, in full configuration,
e. its own Liquid Nitrogen requirements from exhaust Nitrogen gas from system.

24. A method of pollution extraction which allows
a. Freezing the soil, rock layers and aquifer components at pollution locations
b. Heating of the center of the frozen ground and water to release the pollutants
c. Nitrogen carriage of the pollutants from the soil to the extracting tube.
d. Condensing the material with specific zones in the condenser to isolate the various types of pollutants.
e. Collecting the pollutants separately in vessels providing measurement of the amount of each chemical.
f. Determining from the data of amounts extracted for each chemical the portion of expected material anticipated from projected pollution levels.
g. Defining the completion of pollution extraction by observing when freeze zones are expanded and heated volume expanded further and no additional pollutant is pulled from the extraction zone indicating no further expansion is needed, thus ending the extraction effort for that chemical at that specific location.

25. A method of creating and using ice barriers in the freeze zone to seal the extraction zone from air leaks by enabling ice sealing of the aquifer or other layers to block air passage from those zones from top to bottom of those segments of the rockbed.
